(19) United States
(12) Patent Application Publication
(10) Pub. No.: US 2016/0055444 A1
(43) Pub. Date: Feb. 25, 2016

(54) MULTI-USER INTEGRATED INTERACTION

(71) Applicant: Microsoft Technology Licensing, LLC, Redmond, WA (US)

(72) Inventors: Srigiriraju Kishan Chetan, Copenhagen (DK); Brett Justin Rafuse, Issaquah, WA (US); Marian Fechete, Copenhagen (DK); Nikola Jelisavac, Copenhagen (DK); Jujhar Singh, Clyde Hill, WA (US); Prashanth GanapathyRaj, Redmond, WA (US); Bharath Srinivasan Varadarajan, Tamil Nadu (IN); Ted Cyrek, Issaquah, WA (US)

(21) Appl. No.: 14/571,495

(22) Filed: Dec. 16, 2014

Related U.S. Application Data
(60) Provisional application No. 62/040,077, filed on Aug. 21, 2014.

(51) Int. Cl. G06Q 10/06

(52) U.S. Cl. CPC G06Q 10/063112

(57) ABSTRACT

A collaboration system receives a user input from a sales user requesting marketing campaign data for a given context. The marketing campaign data, relative to the context of the sales user, is displayed, along with configuration user input mechanisms that can be actuated to allow the sales user to configure certain parts of the marketing campaign.

### CROSS-REFERENCE TO RELATED APPLICATION

The present application is based on and claims the benefit of U.S. provisional patent application Ser. No. 62/040,077, filed Aug. 21, 2014, the content of which is hereby incorporated by reference in its entirety.

### BACKGROUND

Computer systems are currently in wide use. Such computer systems often control one or more controlled systems. Many companies or organizations make use of such computer systems in a variety of ways, including using computer systems to control and perform broad communication activities with external endpoints, and to perform configuration and control activities to configure and control other computer systems.

For instance, many organizations control communication systems to perform communications and compile and interpret data resulting from those communications. They can use the compiled data to control other processes or systems. Such activities can have a wide variety of purposes. However, it can be difficult for multiple different users of the computer system to access the same information, and to propagate information across the computer system and the communication mechanisms.

The discussion above is merely provided for general background information and is not intended to be used as an aid in determining the scope of the claimed subject matter.

### SUMMARY

A collaboration system senses a user interaction from a first user requesting data for a given context in a computing system. The data, relative to the context of the first user, is displayed, along with configuration user input mechanisms that can sense user interaction to control the computing system so the first user can configure certain parts of the computing system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computer system architecture.

FIG. 1A is a block diagram of a recipient resolver.

FIG. 1B is a flow diagram of one example of the operation of the system in configuring a computing system.

FIG. 2 is a flow diagram illustrating one example of the operation of the architecture shown in FIG. 1 in allowing a first user to access and configure parts of a computing system.

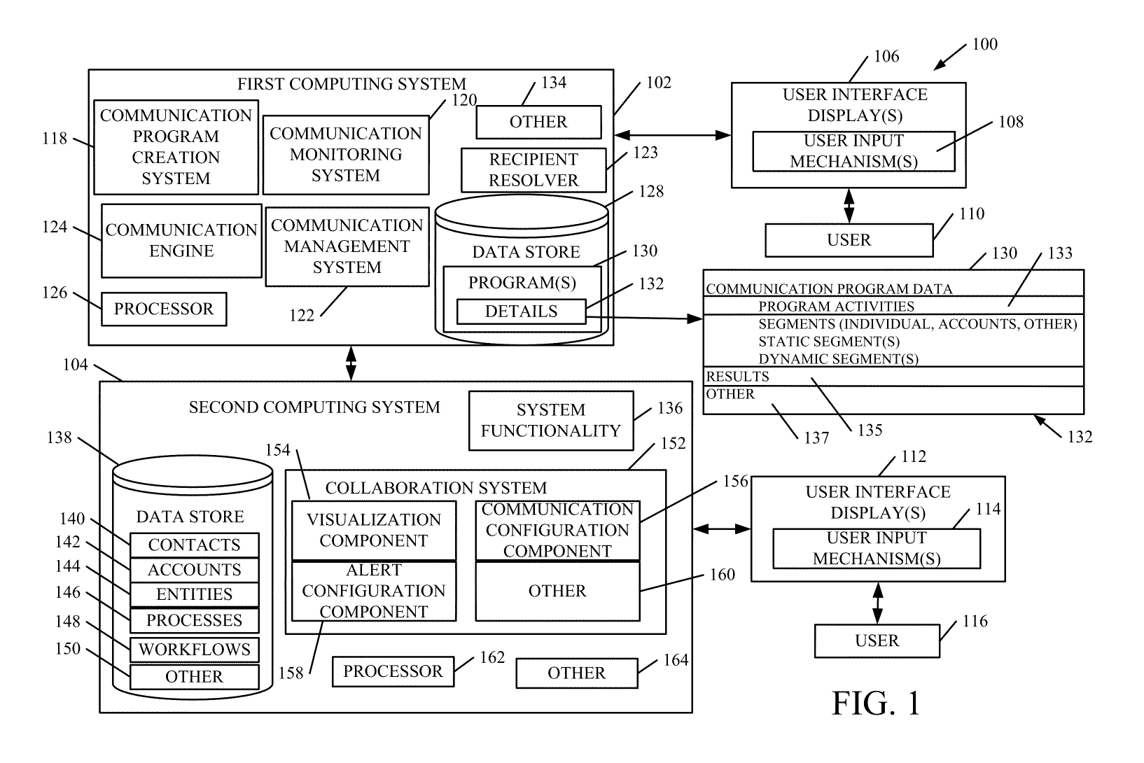

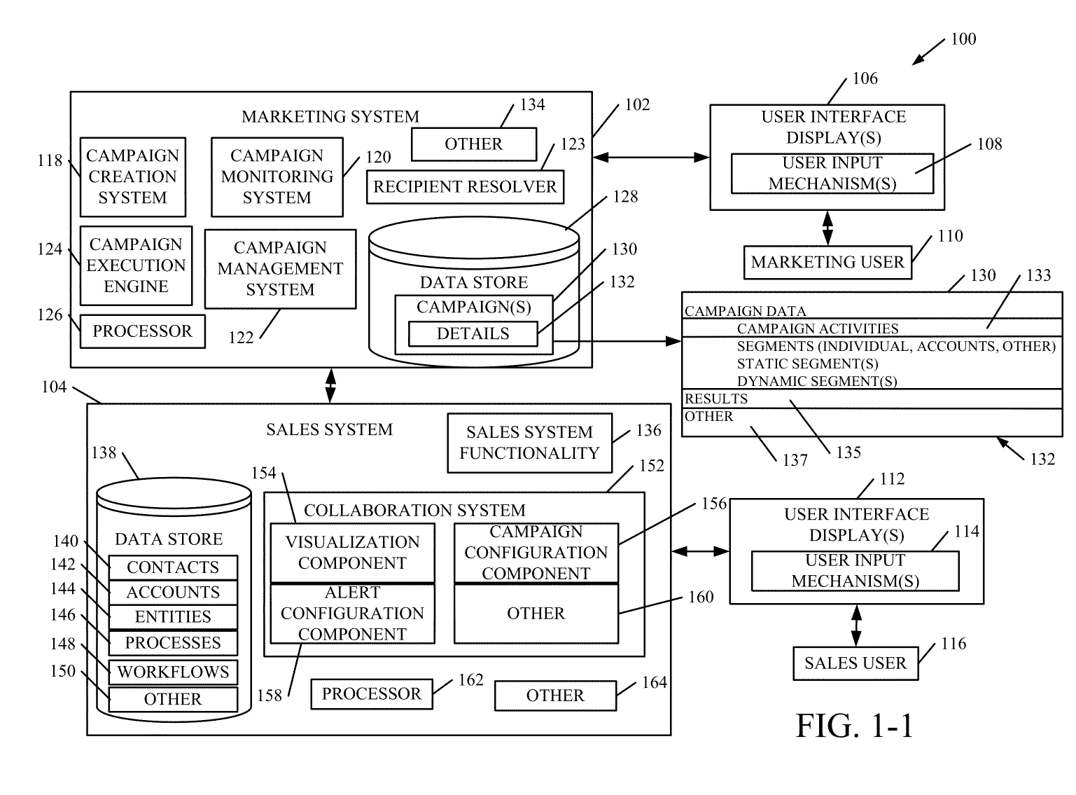

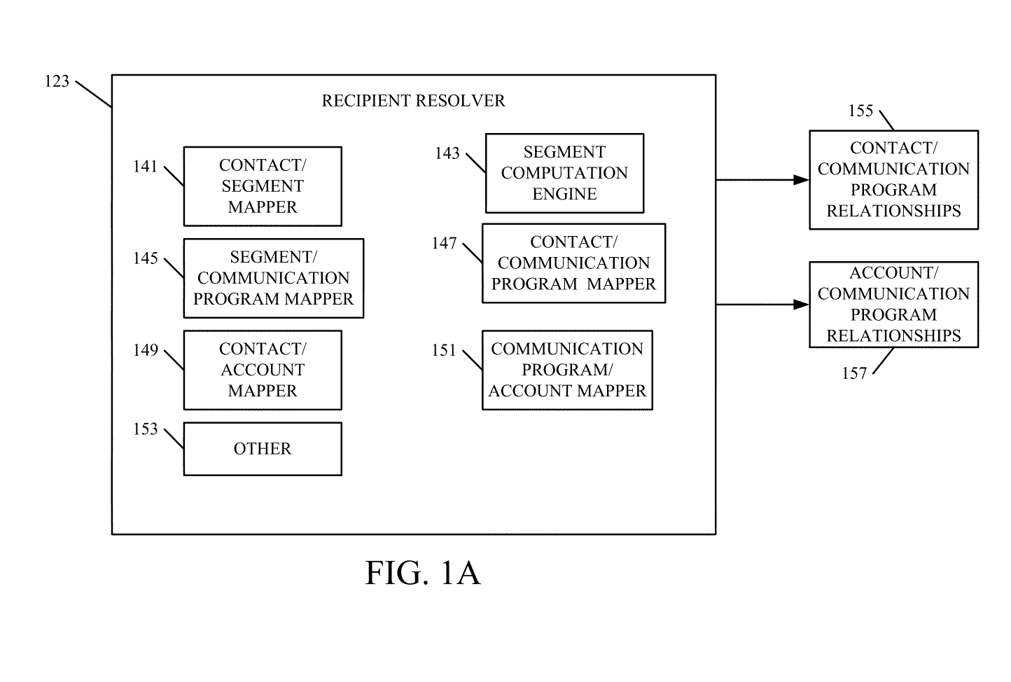

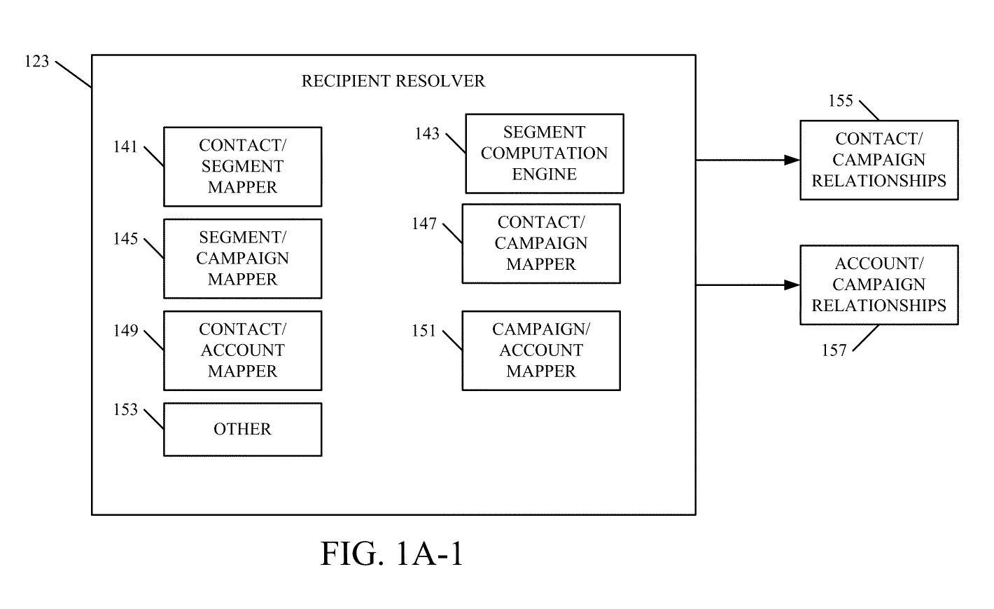

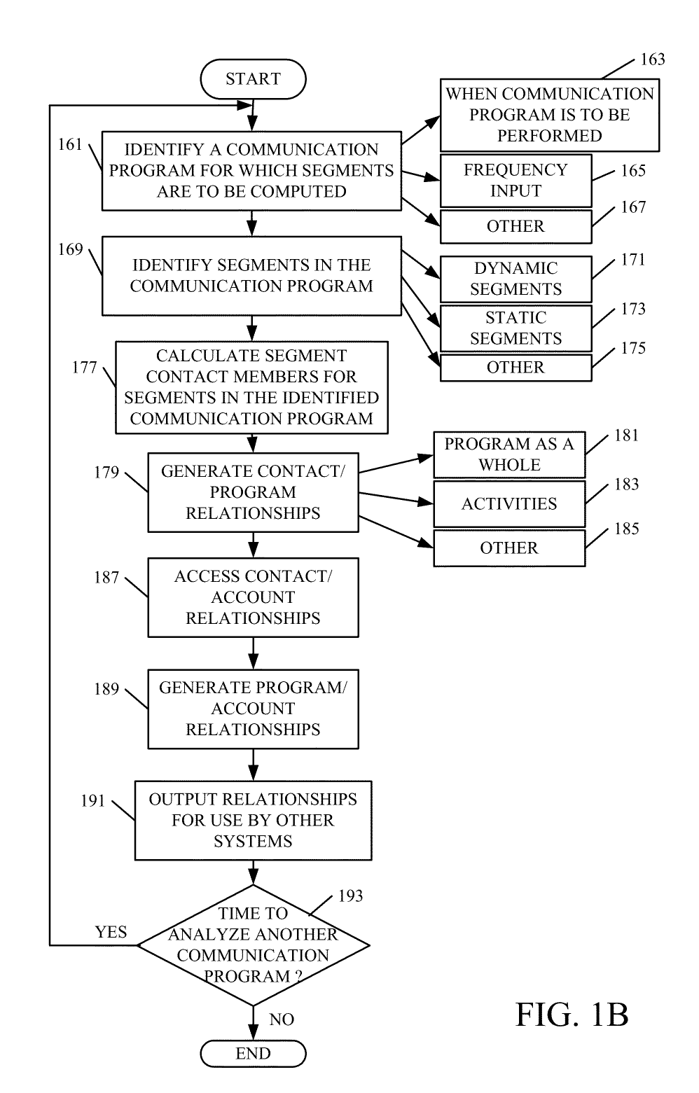

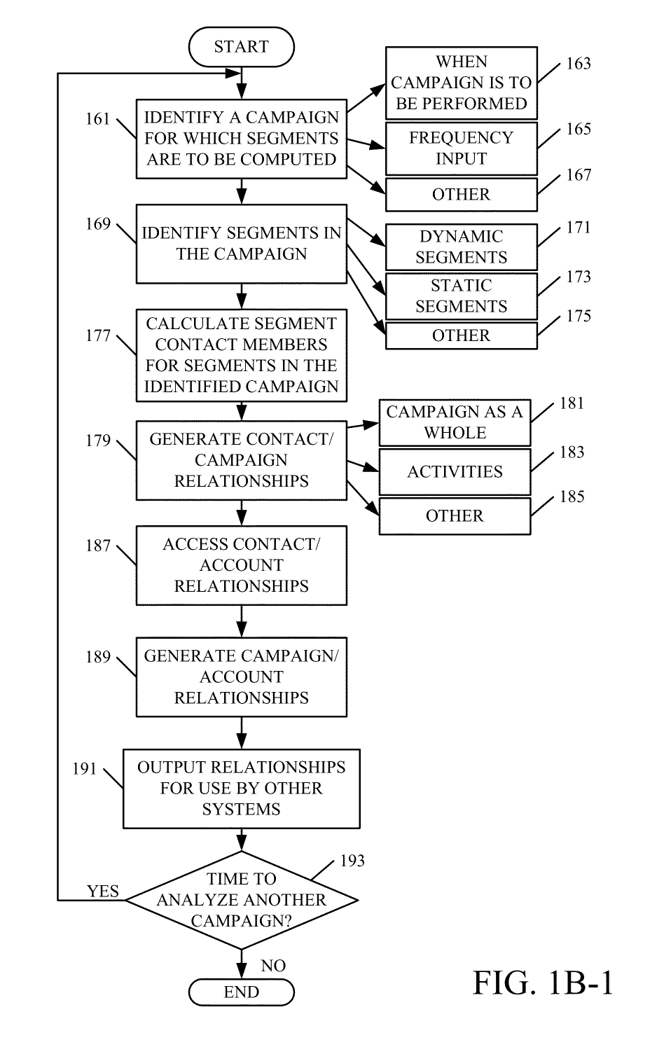

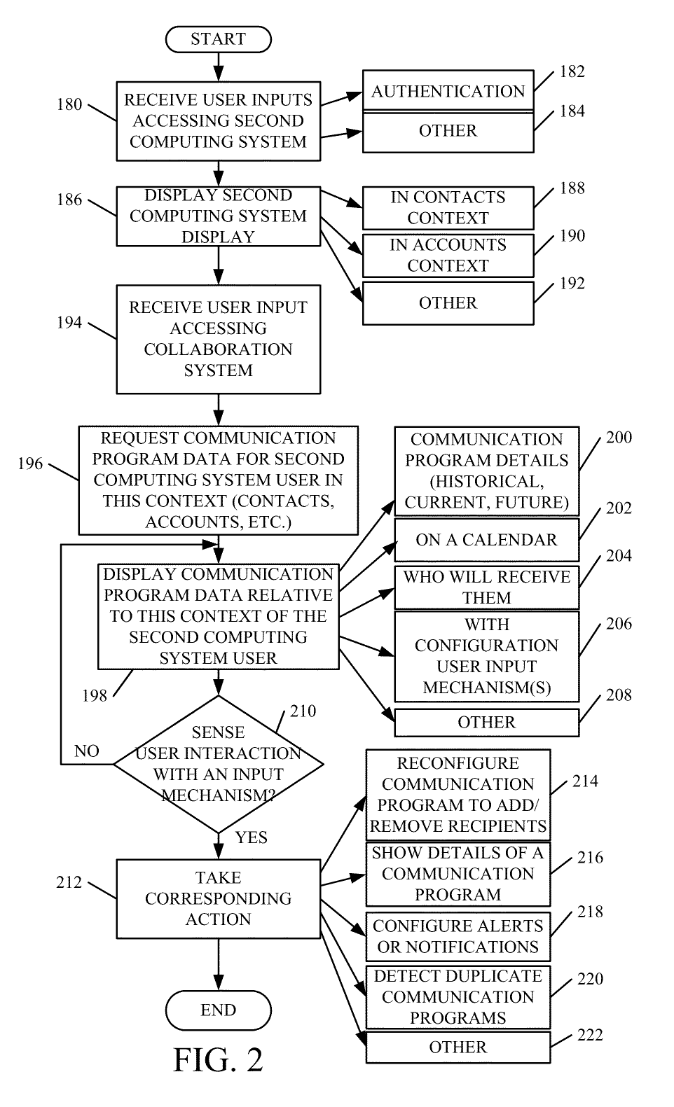

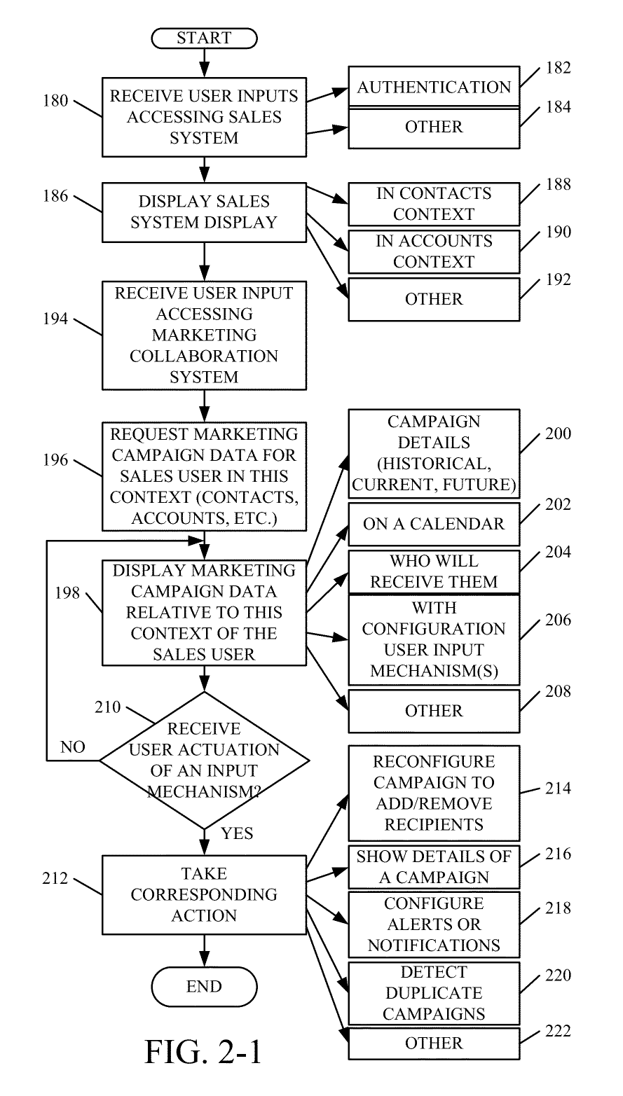

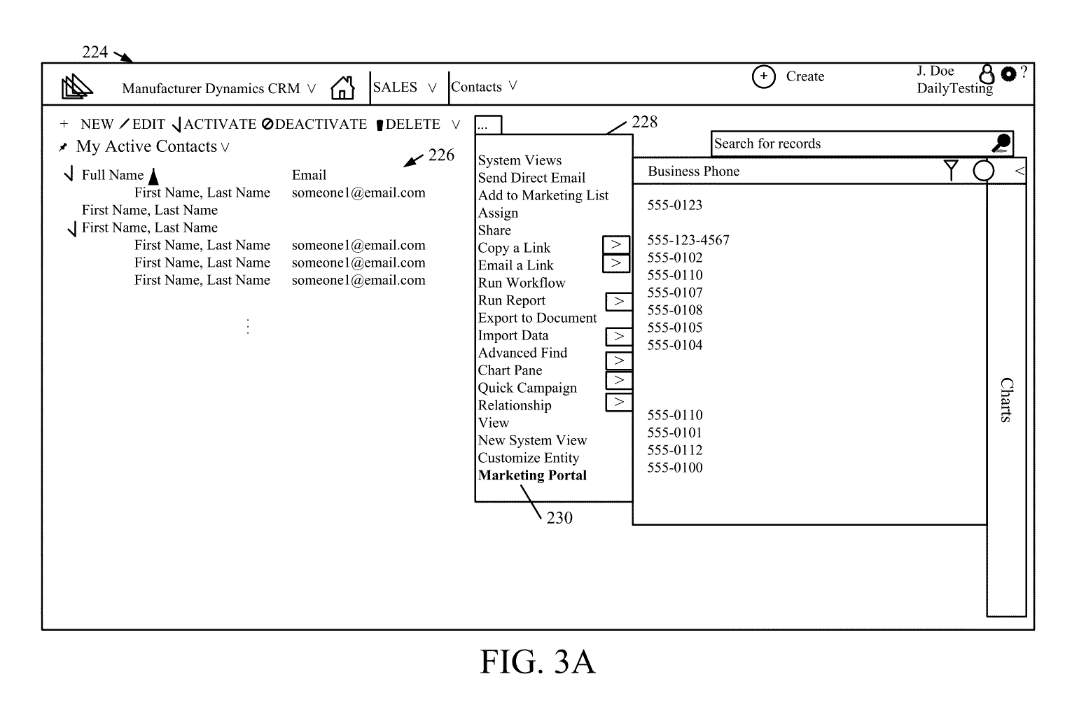

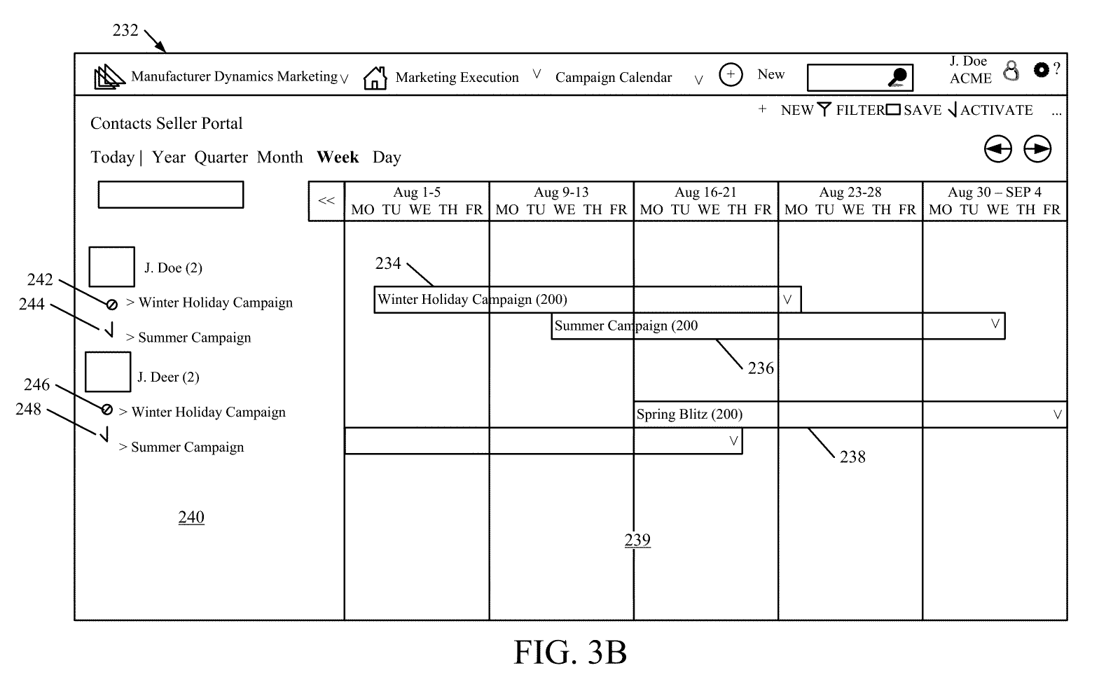

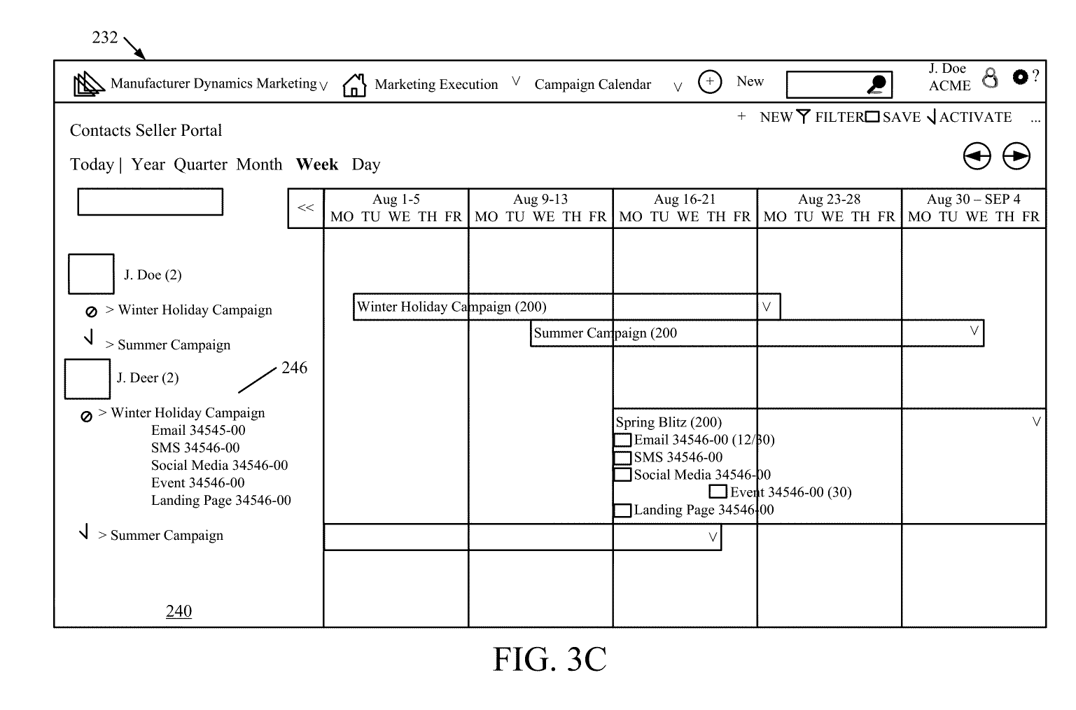

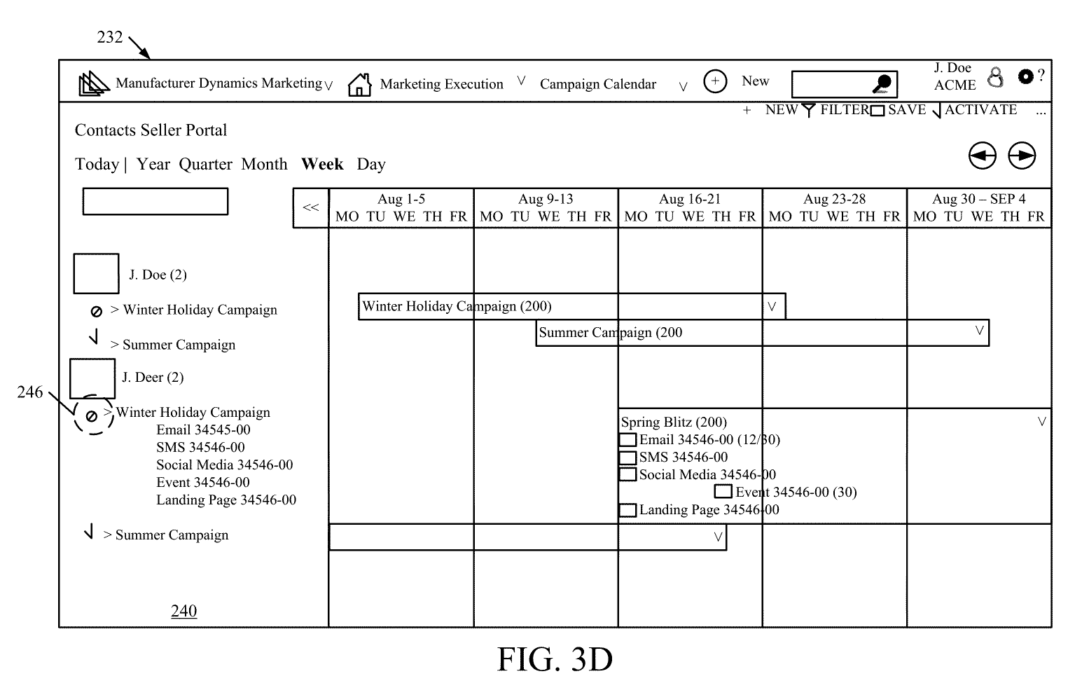

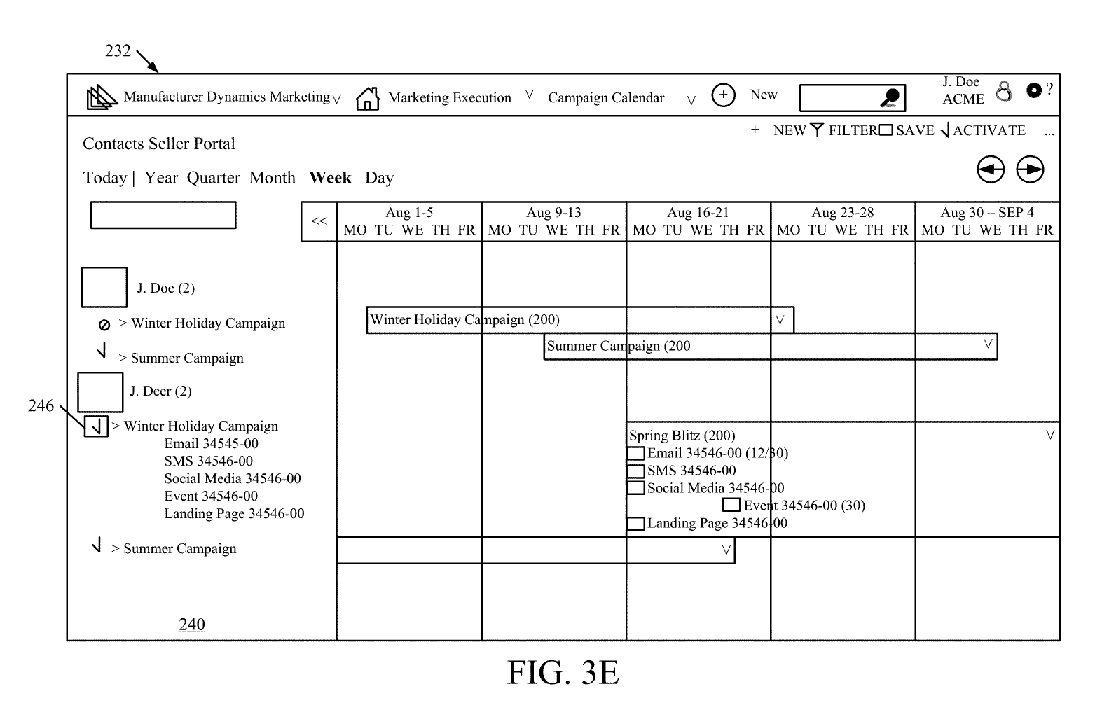

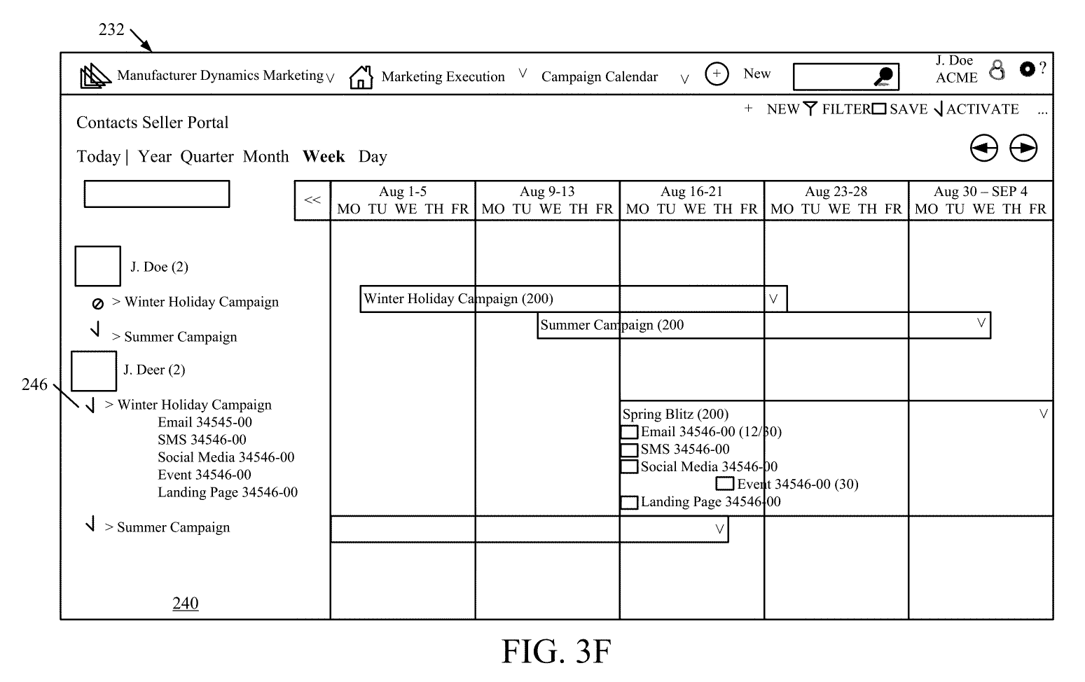

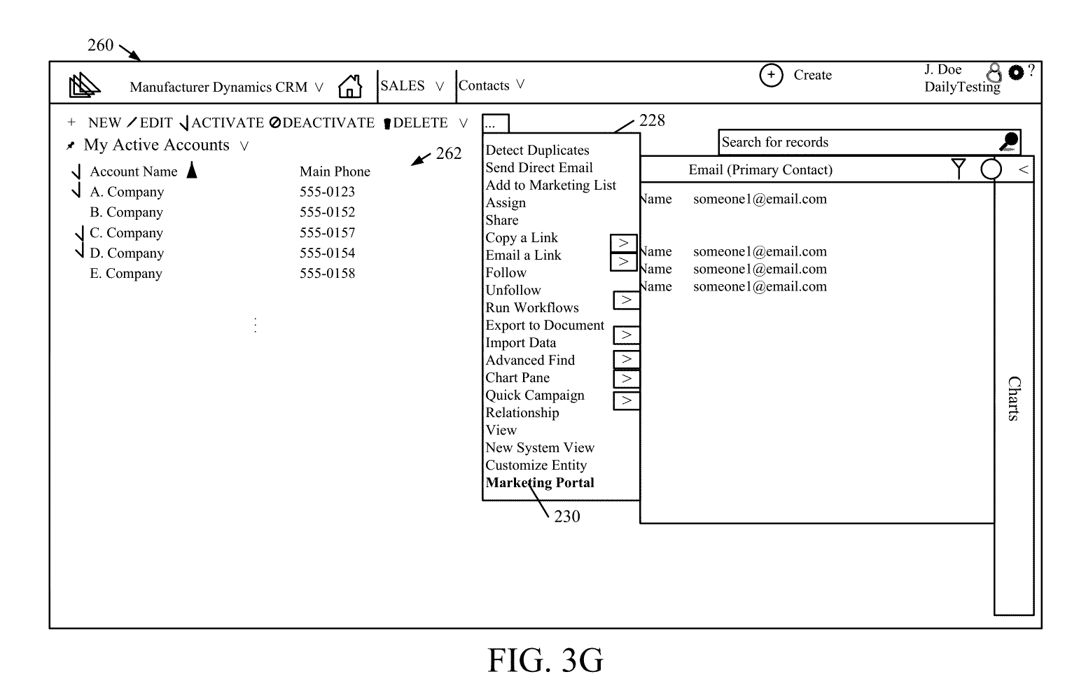

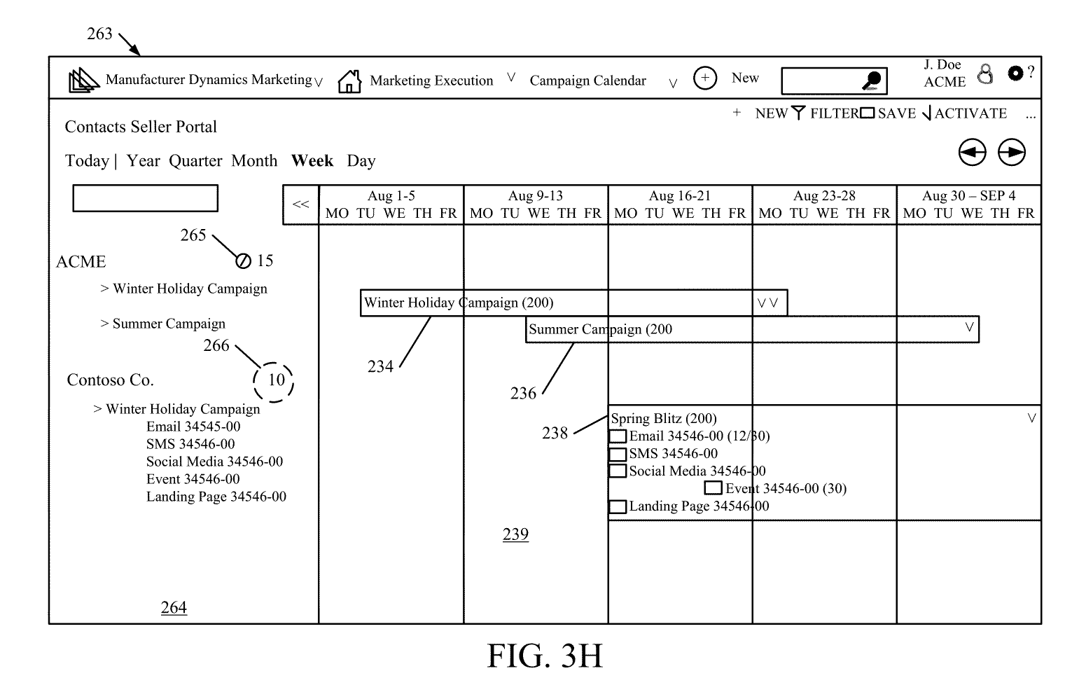

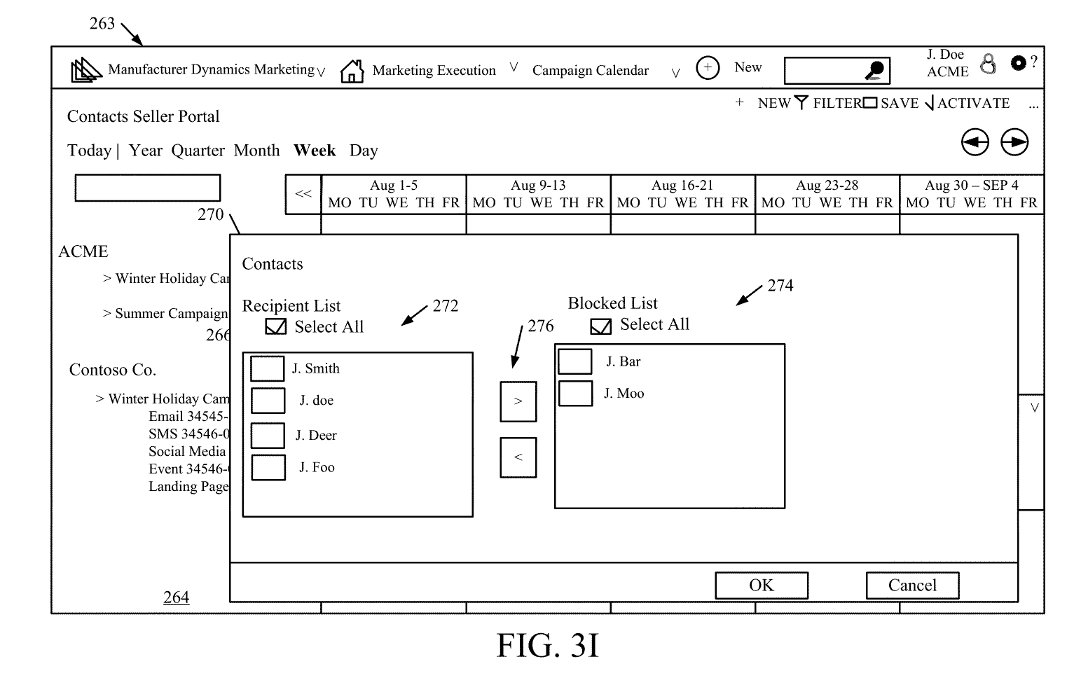

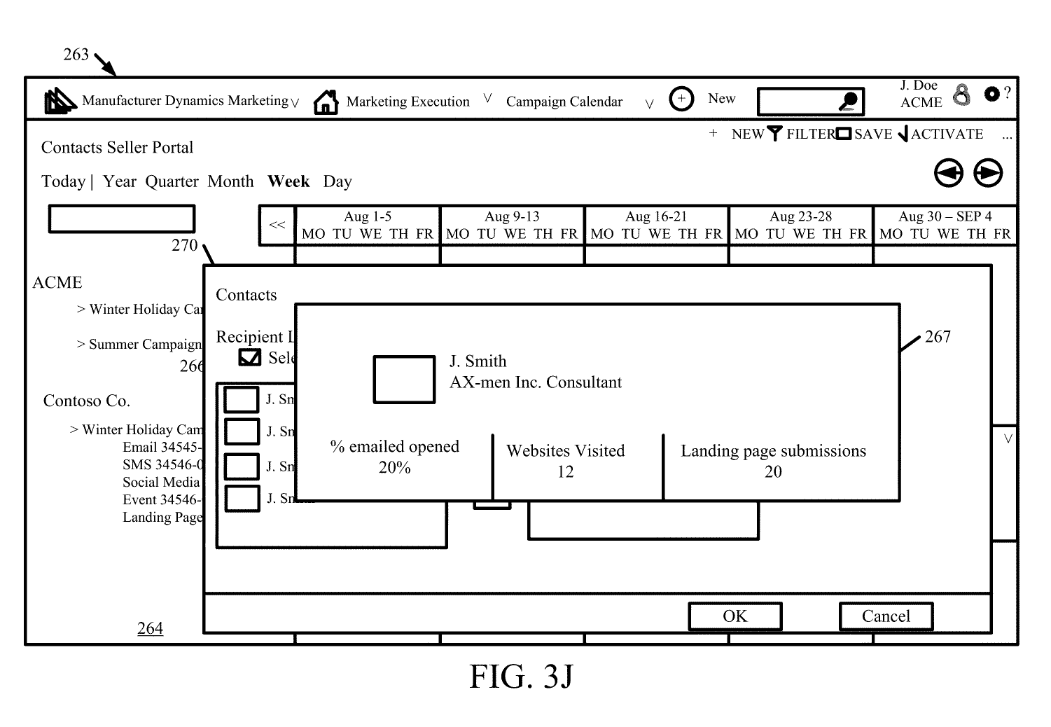

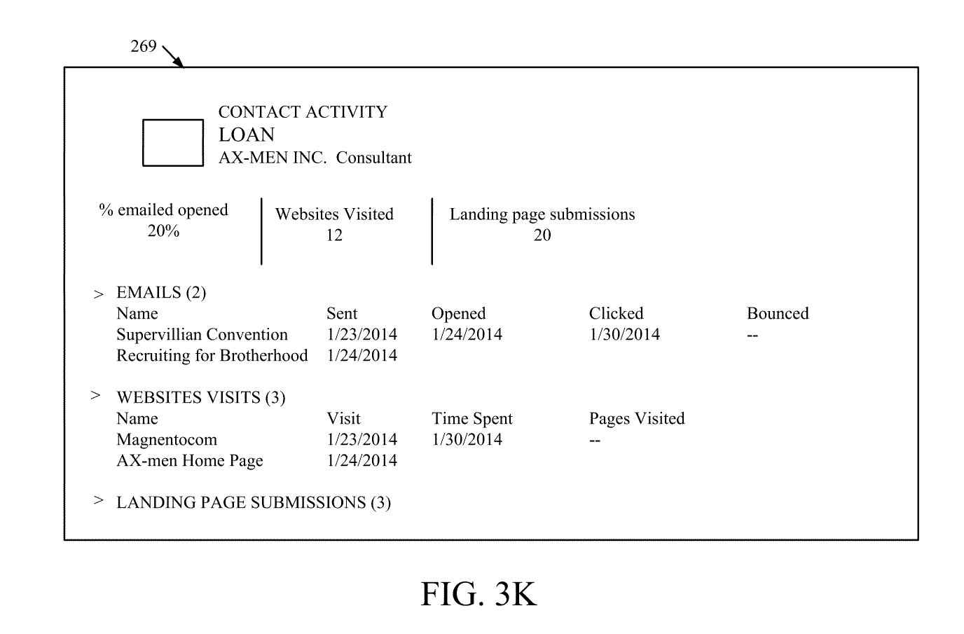

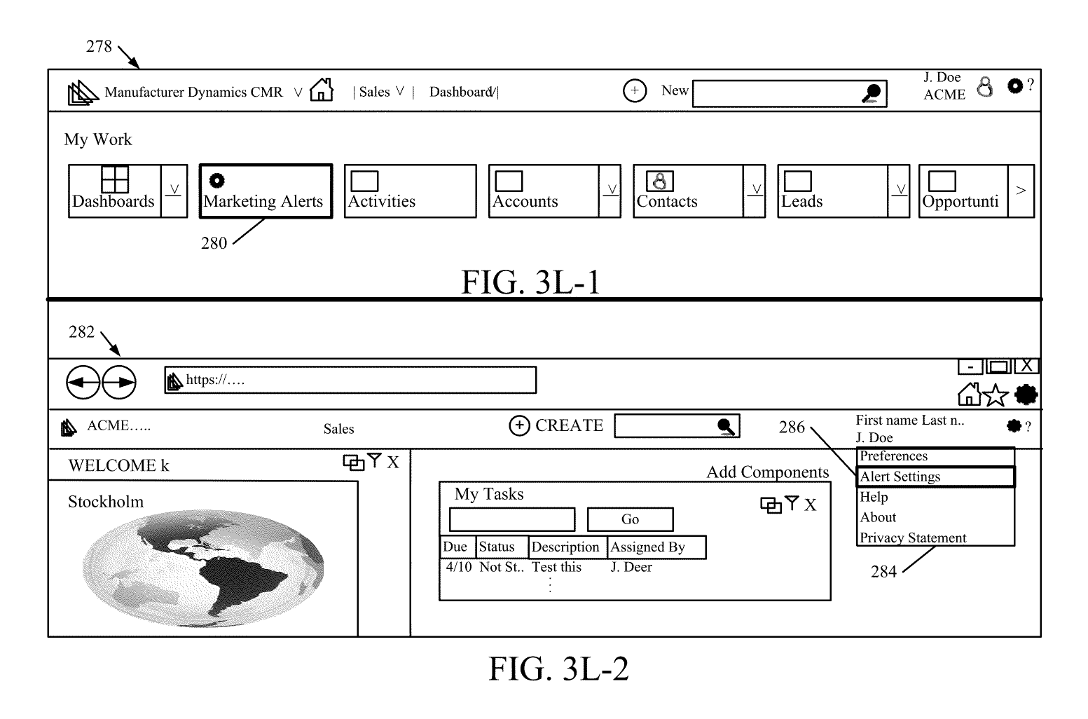

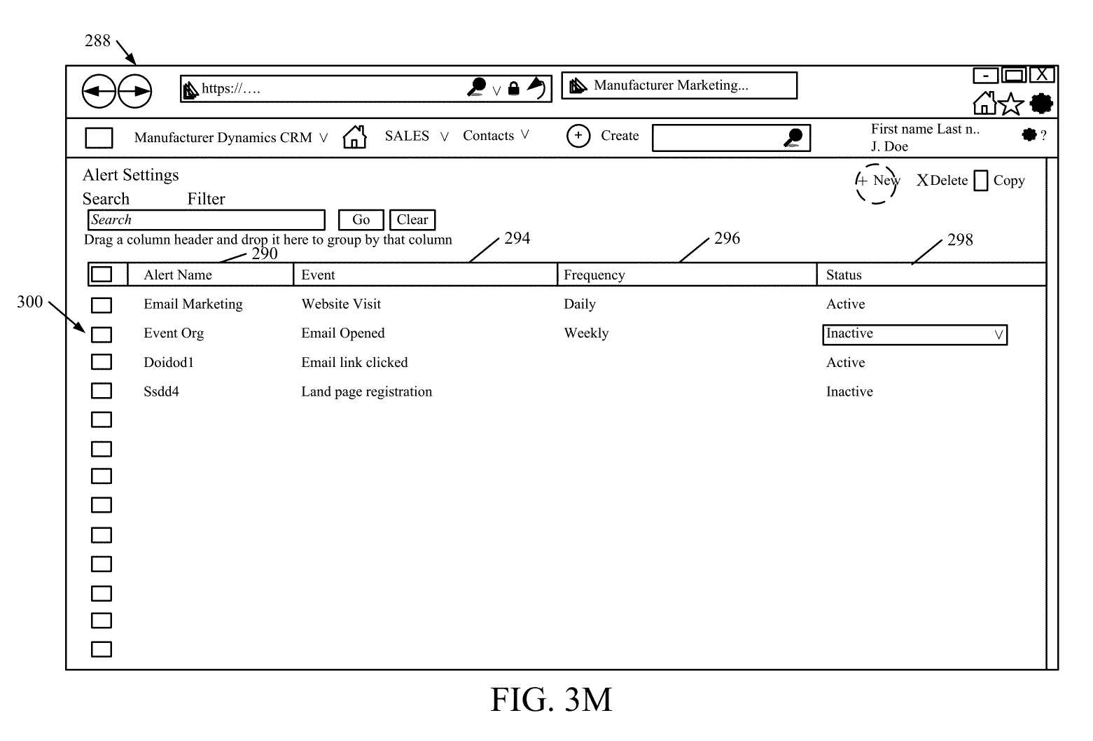

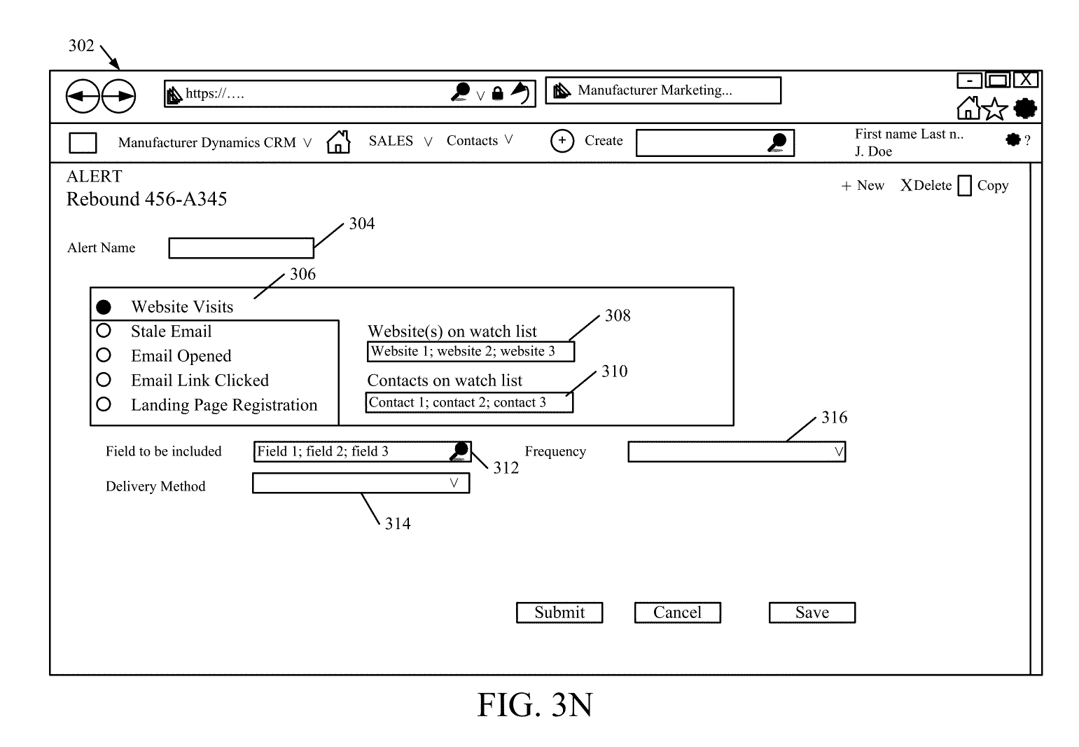

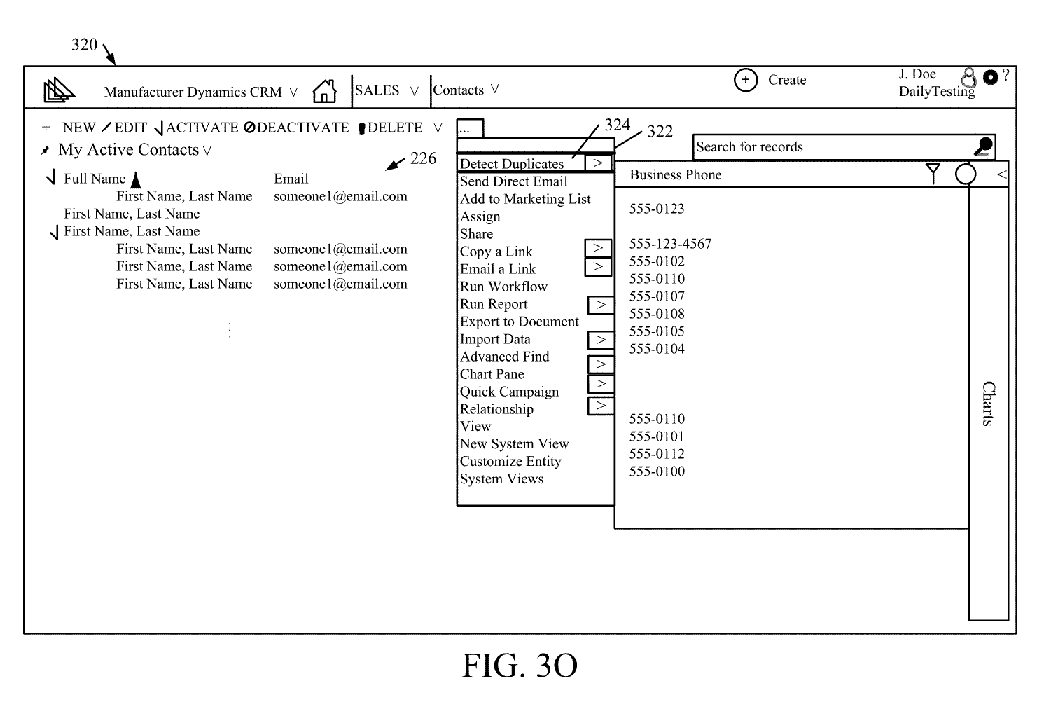

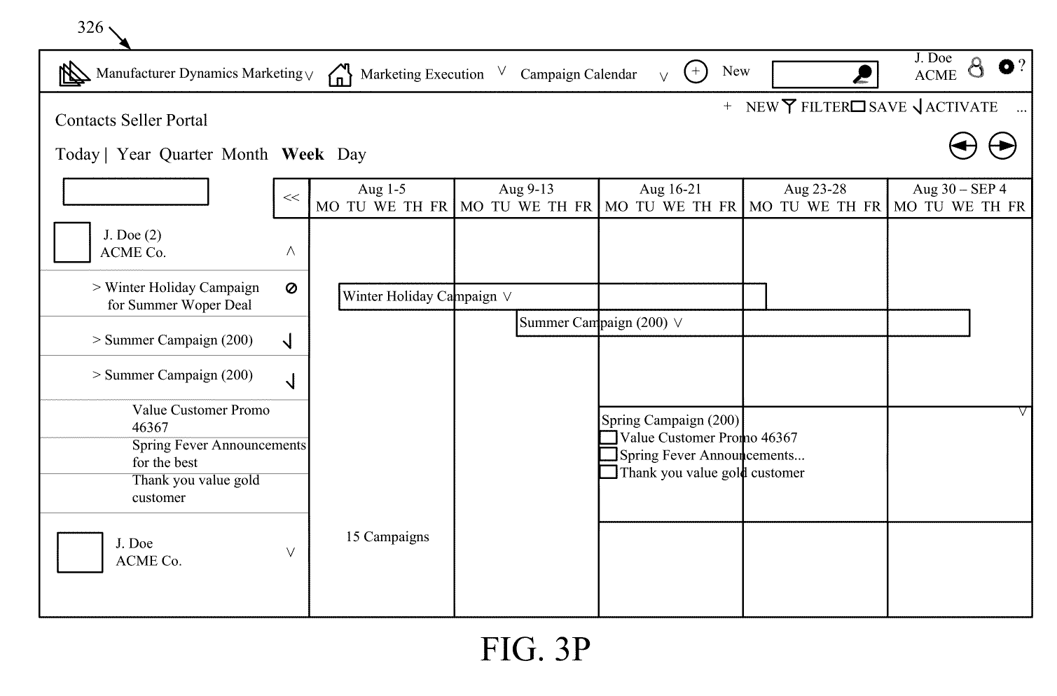

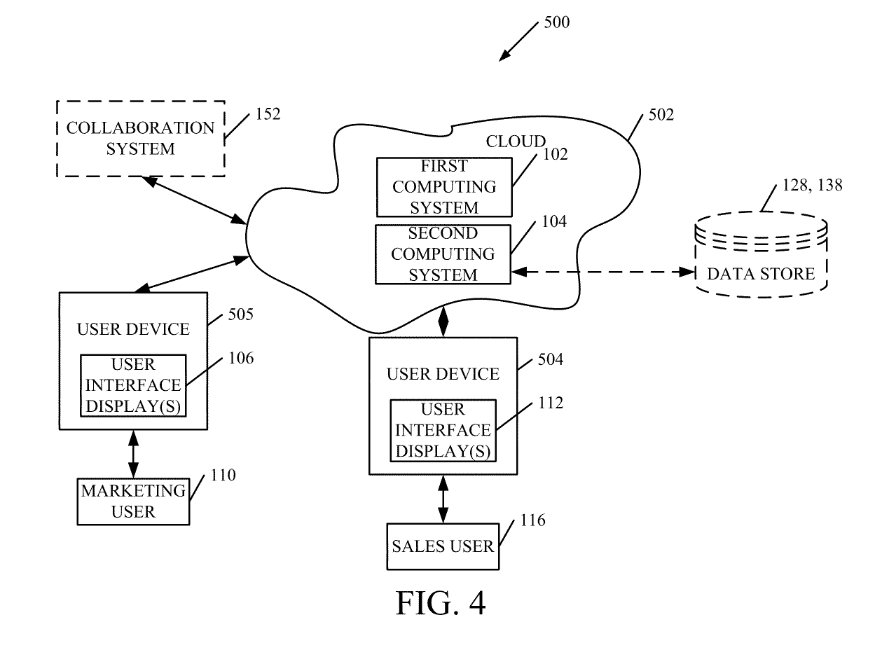

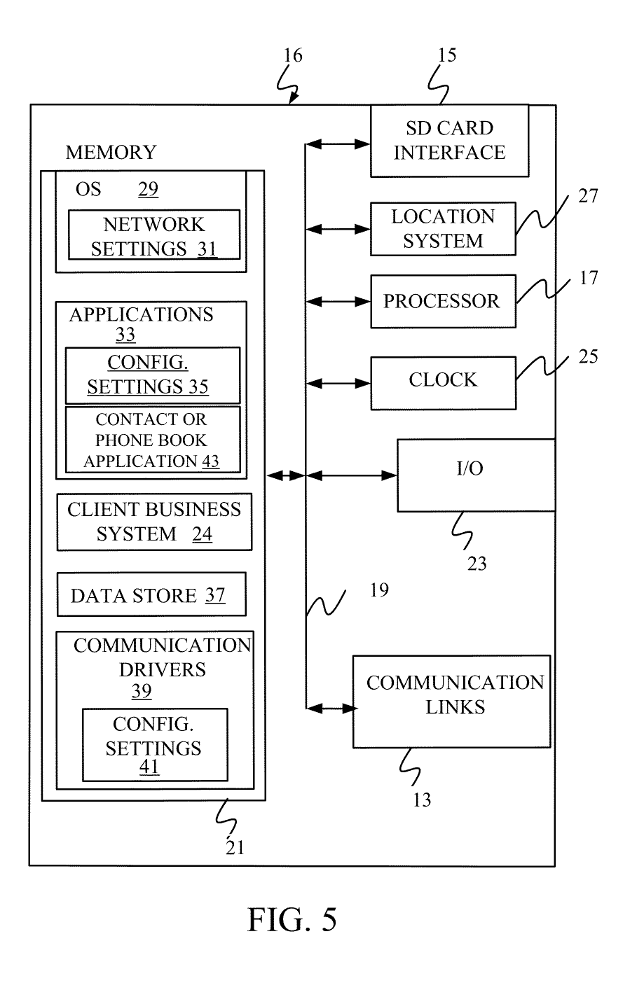

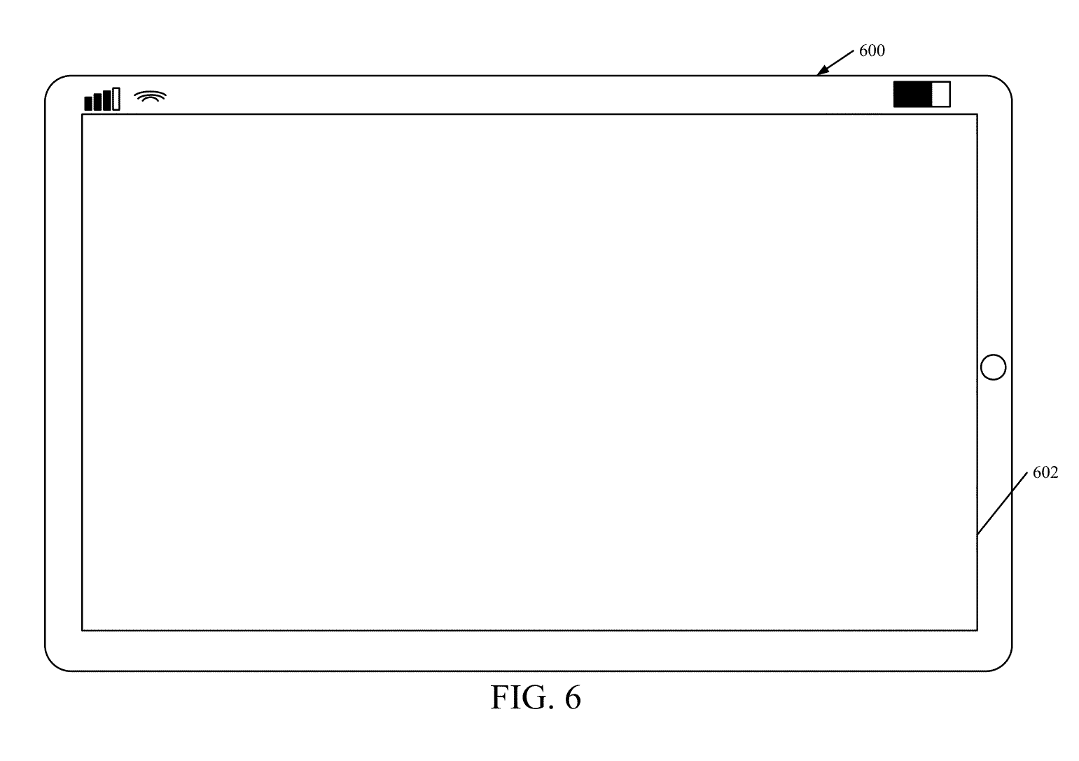

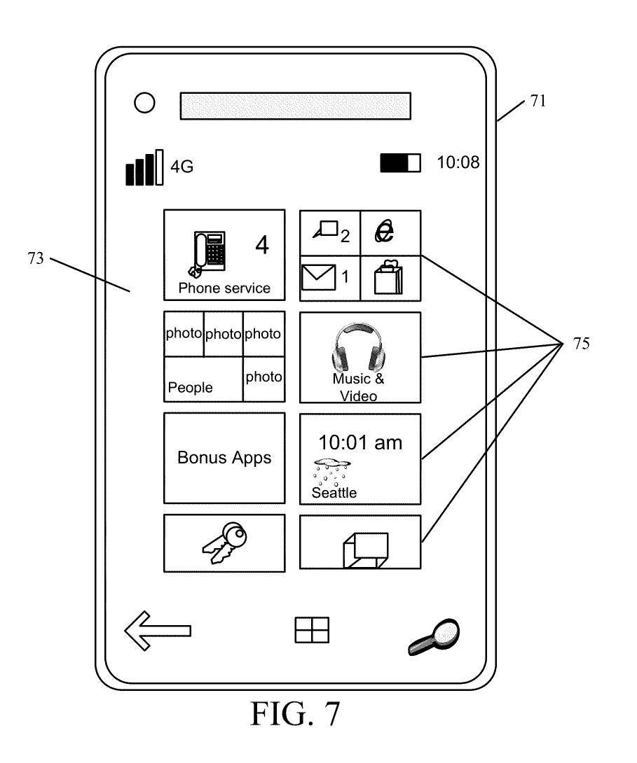

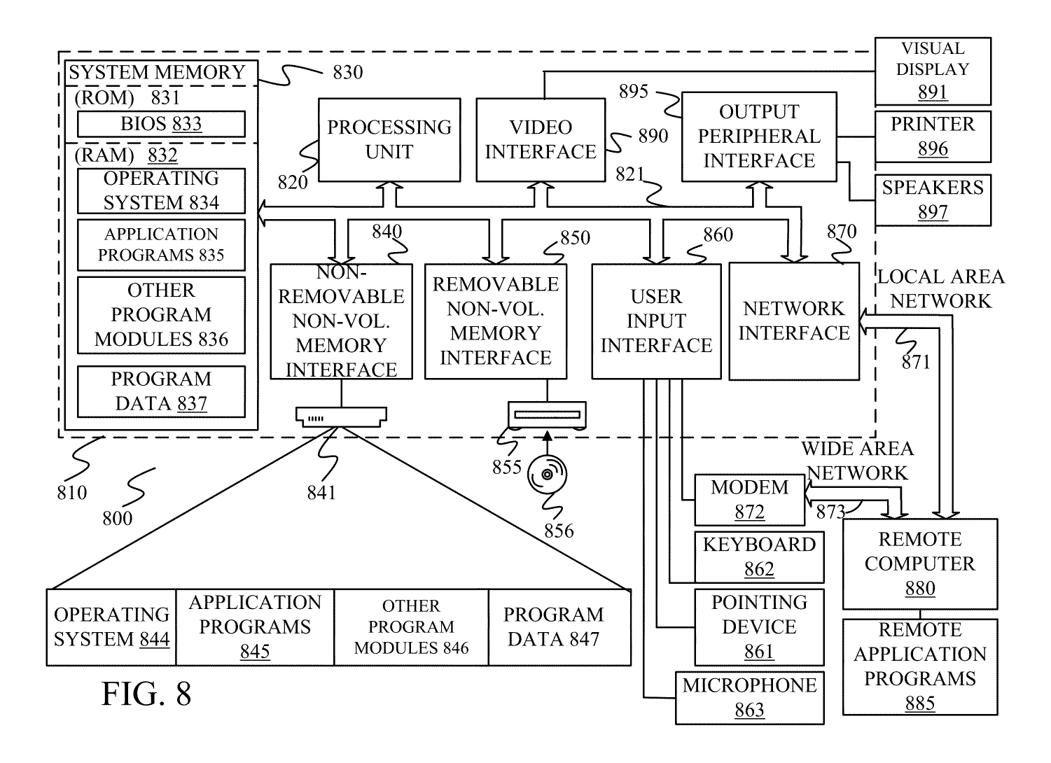

FIGS. 1-1, 1A-1, 1B-1, and 2-1 show the previous figures in the context of a given scenario.

FIGS. 3A-3P show various user interface displays.

FIG. 4 shows the architecture illustrated in FIG. 1, disposed in a cloud computing architecture.

FIGS. 5-7 show various examples of mobile devices.

FIG. 8 is one illustrative computing environment.

### DETAILED DESCRIPTION

Many organizations perform communication activities in one context, such as in a context in which the organization attempts to identify leads (or prospects). Some of these communications activities are arranged to begin by communicating information that conveys introductory material to a set of recipients introducing the recipients to a product to cultivate a relationship with the individual until they purchase the product. The leads can be individual people or organizations that are ultimately identified as being likely to buy the goods or services (or to continue to buy the goods or services, if they are already a customer) of the organization that is performing the communication activities. Processing systems can sense physical characteristics or parameters corresponding to the recipients and calculate scores. The leads can be scored, based on certain parameters, and the higher scoring leads (or prospects) can be identified as a segment to which the organization may direct certain activities, or to be surfaced and identified to a person in a relevant context in the organization (such as to a salesperson).

Many of the same organizations also use computer systems to perform communication activities in a second context, such as in a context in which the organization conducts the sales operations of the organization. This may include, for instance, sensing parameters and performing analysis to surface sales opportunities, to surface or control workflows that are used to control a process of qualifying and developing the sales opportunities, engaging contacts at organizations representing those opportunities, proposing or negotiating various aspects of a potential sale, and ultimately closing a sale. These are only examples of control workflows that can be surfaced.

However, it can be difficult for personnel in the two different contexts within an organization to collaborate. This problem is exacerbated in the area of multi-channel communication systems that are targeted at various accounts or contacts or individuals managed by a given user in a given context. As an example, it may be that a given sales representative has a fairly detailed understanding of the personal preferences or other information regarding the sales representative's accounts or contacts. This may be helpful to a marketer. In addition, a marketing person may have relatively detailed information about how a given individual or organization has responded to marketing campaigns in the past. This may be useful to sales representatives. However, it can be very difficult for the computing system to control the processes so the two different individuals can collaborate to configure or otherwise control the operations, workflows or processes. This is exacerbated in systems in which the communication activities are multi-channel activities that are conducted across multiple different communication channels (such as email, postal mail, texting, social network communications, telephone or cellular communications, other mobile device communications, network communications, professional network or website communications or other communications).

FIGS. 1, 1A, 1B, and 2 will first be discussed with respect to a set of computing systems, with different users. The computing systems are configured to allow the users to configure the systems to control a communication system to perform communication operations. FIGS. 1-1, 1A-1, 1B-1, 2-1 and 3A-3P will then be described for one example of a scenario. While the blocks in both sets of Figures are similarly numbered, those in the latter set are modified to reflect the scenario they are describing. FIGS. 1, 1A, 1B and 2 will be described first, and then the remaining Figures will be described.

One example scenario will now be described. Of course, this is only one example scenario. FIG. 1 is a block diagram of a computing system architecture 100 that includes first computing system 102 and second computing system 104. System 102 illustratively generates user interface displays 106 with user input mechanisms 108 that sense interaction by a user 110. The user 110 can illustratively interact with user input mechanisms 108 to control and manipulate system 102 to create, monitor, manage and execute communication systems or communication programs that perform multi-channel communications to a set of recipients.

System 104 illustratively generates user interface displays 112 with user input mechanisms 114 that sense interaction by user 116. User 116 illustratively interacts with user input mechanisms 114 in order to control and manipulate system 104 in performing various activities and in reviewing and managing communication programs or systems relative to the context of user 116 within system 104.

In the example shown in FIG. 1, system 102 comprises communication program creation system 118, communication monitoring system 120, communication management system 122, recipient resolver 123, communication engine 124, processor 126, data store 128 (that, itself, stores information for various communication systems or programs 130 and the corresponding details 132 of those systems or programs). The data stored in data store 128 can correspond to communication systems or programs that have been created and are to be run in the future, those that are currently underway, and historical information with respect to communication systems or programs that were run in the past. System 102 can also illustratively include other items 134 as well.

User 110 can illustratively access communication program creation system 118 in order to create a communication program. System 118 thus illustratively includes components that sense user interactions that allow user 110 to identify segments 131 to which communication activities in the communication program will be addressed. The segments can be static segments which comprise a list of contacts or individuals. The segments can also be dynamic, in which case a query is executed to identify individuals to receive the corresponding communication program. System 118 also illustratively includes components that sense user interaction and allow user 110 to configure the program to take various actions or perform activities 133 (which can be multi-channel activities), and to identify various responses that a recipient can take with respect to the communication program.

Once the program is created using system 118, user 110 can monitor the performance of the communication system or program using communication monitoring system 120. System 120 illustratively includes analytics components that aggregate information and other performance data 135 relative to the individual actions taken in the communication system or program. For instance, various performance data can be sensed and aggregated to generate performance measures or metrics indicative of the overall performance of the communication system or program, or certain sub-portions of the communication system or program.

While the communication system or program is being run, user 110 can manage the system or program, by making changes or otherwise, using communication management system 122. System 122 allows the user to reconfigure and modify the various actions or other items in the communication, even while it is being run.

Communication engine 124 is illustratively configured to automatically run the communication system or program, after it is created by user 110. By automatically, it is meant that execution is done without the need for substantially any other user actions, other than perhaps receiving a user input to start or activate the execution. Thus, when user 110 has created and activates a communication system or program, communication engine 124 automatically takes actions defined by the created communication system or program (such as the multi-channel communication activities), to execute the system or program directed to the selected recipient segment.

Recipient resolver 123 illustratively runs intermittently or continuously to identify which contacts or individuals will receive which communications. This is described in greater detail below with respect to FIGS. 1A and 1B.

Second computing system 104, as shown in FIG. 1, comprises system functionality 136, data store 138 (which can, itself, include contacts 140, accounts 142, entities 144, processes 146, workflows 148 and other business records or other data 150), and collaboration system 152 (which, itself, includes visualization component 154, communication program configuration component 156, alert configuration component 158 and it can include other items 160 as well). System 104 can also include other items 164. In operation, user 116 can access system functionality 136 to perform various functions. For instance, functionality 136 can run various applications, which implement processes 146 and workflows 148, and which can operate on entities 144 to enable user 116 to control computing system 104 to perform various activities.

Collaboration system 152 illustratively allows user 116 to collaborate in the communication systems or programs generated using system 102. Visualization component 154 illustratively allows user 116 to view information, even relatively detailed information, for programs 130 stored in system 102. Communication program configuration component 156 allows user 116 to provide certain configuration inputs to reconfigure the programs, relative to the contacts 140 and accounts 142 of user 116. By way of example, user 116 can illustratively block certain accounts or contacts from receiving the communications, or individual activities in a program, or unblock one or more of them. Alert notification component 158 illustratively allows user 116 to receive alerts or notifications generated from one or more communication systems or programs. Thus, user 116 can see how the programs are organized, graphically, relative to the user's contacts 140 and accounts 142. User 116 can illustratively open and close a program calendar view that shows the details and timing of various communication systems or programs (such as e-mails, landing pages, tasks, etc. that are included in the systems or programs) on a timeline view. User 116 can also view his or her accounts' or contacts' sensed interactions or other behavior relative to the communication systems or programs (such as how they responded to different activities in the program). In one example, this can be viewed during runtime, even as engine 124 is performing the multi-channel communication activities. Further, user 116 can provide at least some configuration inputs to reconfigure the communication systems or programs so that it is either directed to, or blocked from, certain contacts or accounts of user 116.

FIG. 1A shows one example of recipient resolver 123 in more detail. FIG. 1B shows an example of a flow diagram illustrating the operation of recipient resolver 123. FIGS. 1A and 1B will now be described in conjunction with one another.

Resolver 123 illustratively includes contact/segment mapper 141, segment computation engine 143, mapper 145, contact/communication program mapper 147, communication program/account mapper 151, and it can include other items 153 as well. In operation, resolver 123 calculates which contacts 140 receive activities in which communication programs 130. It also calculates which accounts 142 contain contacts that will receive activities of which programs 130. Because these things can change over time, resolver 123 calculates these relationships intermittently or continuously. It outputs these relationships 155 and 157, respectively for use by system 104.

In doing so, resolver 123 first identifies a communication system or program for which segments are to be resolved. This is indicated by block 161 in FIG. 1B. This can be done in a variety of different ways. For instance, resolver 123 can calculate the relationships more frequently for communication systems or programs that are currently being conducted or that are to be conducted in the near future than for those that are to be conducted further out in the future. This is because some users are more likely to change the communication systems or programs that are run further in the future than those that are nearer. Therefore, resolver 123 does not spend as many computing resources on the more distant programs. This is indicated by block 163 in FIG. 1B. It can also determine which program to select based on configuration inputs or in other ways, as indicated by blocks 165 and 167.

When a communication system or program has been identified, engine 143 then identifies which segments have been identified for the system or program. This is indicated by block 169. They can be dynamic segments 171, static segments 173 or others 175. If there are any dynamic segments, then engine 143 runs the associated queries to identify the current segments. Mapper 145 maps those segments to the identified communication system or program. Contact/segment mapper 141 identifies which contacts 140 belong to which segments for the program. This is indicated by block 177. Based on that information, contact/communication program mapper 147 then identifies relationships (or maps) 155 indicating which contacts 140 are mapped to this communication system or program. This is indicated by block 179. The relationships can indicate whether a contact is to receive any communications or activities for the program (e.g., whether the contact is related to the program as a whole), or it can identify the specific activities within a program that the contact is to receive. These are indicated by blocks 181 and 183 in FIG. 1B. The relationships 155 can be identified in other ways as well, as indicated by block 185.

Contact/account mapper 149 then accesses pre-existing relationships that identify which contacts 140 are related to which accounts 142. It can identify the particular roles associated with the contacts 140, and other information as well. Accessing the contact/account relationships is indicated by block 187.

Based on this information described above, communication system/account mapper 151 then generates the program/account relationships 157 (or maps) that identify which accounts 142 have contacts 140 that will receive activities from the program. In one example, if a given account 142 has any contacts 140 that will receive any activities from the communication system or program, then a relationship is created. This is just one example. Generating the communication system/account relationships 155 is indicated by block 189 in FIG. 1B.

The relationships (or maps) 155 and 157 are then output for use by system 104. This is indicated by block 191. Resolver 123 then determines whether it is time to process another communication system or program. This is indicated by block 193. If so, processing reverts to block 161. If not, resolver 123 waits until it is time to process another system or program.

FIG. 2 is a flow diagram illustrating one example of the operation of architecture 100, in more detail. It is first assumed that resolver 123 is resolving, or has resolved, relationships 155 and 157 as discussed above. System 104 receives an input from user 116 indicating that user 116 is accessing system 104. This is indicated by block 180 in FIG. 2. This can be performed by user 116 providing authentication information 182, or other information 184.

In response, system 104 illustratively displays a system display. This is indicated by block 186 in FIG. 2. The system display can be generated in a variety of different contexts. For instance, it can be displayed in the context of the contacts 140 of user 116. This is indicated by block 188. It can also be generated in the context of the accounts 142 of user 116. This is indicated by block 190. Of course, it can be displayed in other contexts as well. This is indicated by block 192.

The system display illustratively includes a user input mechanism that allows user 116 to access collaboration system 152. In one example, system 104 then senses user actuation of the user input mechanism to access collaboration system 152. This is indicated by block 194 in FIG. 2. In response, collaboration system 152 illustratively provides a request to system 102, requesting communication program data for this particular user 116, in this particular context. This is indicated by block 196 in FIG. 2. System 102 accesses the relationships generated by resolver 123 to determine which program information (for which program 130) is to be returned to system 152. It obtains and returns that information.

Visualization component 154 then displays communication program data relative to this context of the user 116. This is indicated by block 198. As examples, the visualization component 154 can display details for communication programs that have been run in the past. It can display details for communication programs that are currently run, and for those that are run in the future, or for any or all of these. This is indicated by block 200. The details can include a wide variety of other information. For instance, they can indicate the various communication activities that will be taken, and the timing of those activities, in the given communication system or program. They can also sense user interactions and show how recipients of the communications interacted with them, such as their online behavior in interacting with e-mails sent by the communication system as part of the program, etc. The detailed information can include a wide variety of other details relative to the communication programs that are displayed.

In one example, visualization component 154 displays the communication programs on a calendar view, as indicated by block 202. For instance, the current communication programs can be displayed on one calendar view, while giving the user the opportunity to scroll forward and backward in time (or select previous or subsequent periods in time) to view other communication programs and their detailed information.

The visualization component 154 also illustratively displays how the communication programs affect the particular context that user 116 is viewing. For instance, component 154 can detect that user 116 has opened an application or launched a system in a given context (such as in the context of the user's accounts or contracts). If user 116 is viewing the communication program information in the context of the user's contacts, visualization component 154 will display which of those contacts will be touched by (such as which will receive a communication from) a communication program in the relevant time frame shown on the calendar view. If user 116 is viewing the program material in the context of the user's accounts, then visualization component 154 will reconfigure the display to display which accounts will be touched by the communication system or programs. This is indicated by block 204 in FIG. 2.

Visualization component 154 can generate the display with configuration user input mechanisms that allow user 116 to configure, or reconfigure, certain aspects of the communication system or program. This is indicated by block 206. For instance, user 116 can be provided with user input mechanisms that sense user interactions indicating that the user wishes to block certain accounts or contacts from receiving the communications (or from receiving certain portions of, or activities of, the program). The user input mechanisms can also sense user interactions that allow user 116 to unblock contacts or accounts as recipients of the communication system or its activities.

Of course, the visualization can be generated in other ways as well. This is indicated by block 208.

Collaboration system 152 then determines whether it has sensed user actuation of an input mechanism on the visualization. This is indicated by block 210. If not, processing simply reverts to block 108 where the display is continued. If so, however, then collaboration system 152 takes the action corresponding to the actuated user input mechanism. This is indicated by block 212.

Some examples of actions that can be taken include reconfiguring the communication system to block or unblock recipients. This is indicated by block 214. Interaction with details user input mechanism can be sensed, corresponding to a given program, to display additional detailed information corresponding to that program. This is indicated by block 216. The user can illustratively actuate alert or notification user input mechanisms to subscribe to or otherwise configure alerts or notifications generated from the program. This is indicated by block 218. The user can illustratively actuate user input mechanisms to detect duplicate communication programs. For instance, it may be that, for some reason, a given contact or a given account has been scheduled to receive two instances of the same communication program. User 116 can illustratively actuate a user input mechanism to detect and remedy this as well. This is indicated by block 220. Collaboration system 152 can take other actions as well, and this is indicated by block 222.

FIG. 1-1 is a block diagram of one example of the architecture shown in FIG. 1 as a sales and marketing computing system architecture 100. Thus, first computing system 102 comprises marketing computing system 102 and second computing system 104 comprises sales computing system 104. Marketing system 102 illustratively generates user interface displays 106 with user input mechanisms 108 for sensing interaction by a marketing user 110. The marketing user 110 can illustratively interact with user input mechanisms 108 to control and manipulate marketing system 102 to create, monitor, manage and execute marketing campaigns.

Sales system 104 illustratively generates user interface displays 112 with user input mechanisms 114 for sensing interaction by sales user 116. Sales user 116 illustratively interacts with user input mechanisms 114 in order to control and manipulate sales system 104 in performing sales activities and in reviewing and managing marketing campaigns relative to the accounts or contacts of sales user 116.

In the example shown in FIG. 1-1, marketing system 102 illustratively includes campaign creation system 118, campaign monitoring system 120, campaign management system 122, recipient resolver 123, campaign execution engine 124, processor 126, campaign data store 128 (that, itself, stores information for various marketing campaigns 130 and the corresponding details of those marketing campaigns 132). The data stored in data store 128 can correspond to marketing campaigns that have been created and are to be conducted in the future, those that are currently underway, and historical information with respect to marketing campaigns that were conducted in the past. Marketing system 102 can also illustratively include other items 134 as well.

User 110 can illustratively access campaign creation system 118 in order to create a marketing campaign. System 118 thus illustratively includes components that allow user 110 to identify market segments 131 to which the campaign will be addressed. The segments can be static segments which comprise a list of contacts or individuals. The segments can also be dynamic, in which case a query is executed to identify individuals to receive the corresponding campaign. System 118 also illustratively includes components that allow user 110 to configure the campaign to take various actions or activities 133 (which can be multi-channel activities), and to identify various responses that a recipient can take with respect to the marketing campaign.

Once the campaign is created using system 118, user 110 can monitor the performance of the campaign using campaign monitoring system 120. System 120 illustratively includes analytics components that aggregate sensed information and other performance data 135 relative to the individual actions taken in the marketing campaign. For instance, various performance data can be aggregated to generate performance measures or metrics indicative of the overall performance of the campaign, or certain sub-portions of the campaign.

While the campaign is being conducted, user 110 can manage the campaign, by making changes or otherwise, using campaign management system 122. System 122 allows the user to reconfigure and modify the various actions or other items in the campaign, even while it is being run.

Campaign execution engine 124 is illustratively configured to automatically control the computer system to run the campaign, after it is created by user 110. By automatically, it is meant that execution is done without the need for substantially any other user actions, other than perhaps receiving a user input to start or activate the execution. Thus, when user 110 has created and activates a marketing campaign, campaign execution engine 124 controls the computing system to automatically take actions defined by the created marketing campaign, to execute the marketing campaign directed to the selected marketing segment.

Recipient resolver 123 illustratively runs intermittently or continuously to identify which contacts or individuals will receive which campaigns. This is described in greater detail below with respect to FIGS. 1A-1 and 1B-1.

Sales system 104 illustratively includes sales system functionality 136, data store 138 (which can, itself, include contacts 140, accounts 142, entities 144, processes 146, workflows 148 and other business records or other data 150), collaboration system 152 (which itself, includes visualization component 154, campaign configuration component 156, alert configuration component 158 and it can include other items 160 as well), and processor 162. Sales system 104 can also include other items 164. In operation, sales user 116 can access sales system functionality 136 to perform various sales functions. For instance, functionality 136 can run various business applications, which implement processes 146 and workflows 148, and which can operate on entities 144 to enable user 116 to perform various sales activities.

Collaboration system 152 illustratively allows sales user 116 to collaborate in the marketing campaigns generated using marketing system 102. Visualization component 154 illustratively allows sales user 116 to view campaign information, even relatively detailed campaign information, for campaigns 130 stored in marketing system 102. Campaign configuration component 156 allows sales user 116 to provide certain configuration inputs to reconfigure the campaigns, relative to the contacts 140 and accounts 142 of sales user 116. By way of example, user 116 can illustratively block certain accounts or contacts from receiving the marketing campaign, or individual activities in a campaign or unblock one or more of them. Alert notification component 158 illustratively allows user 116 to receive alerts or notifications generated from one or more marketing campaigns. Thus, user 116 can see how the marketing campaigns are organized, graphically, relative to the user's contacts 140 and accounts 142. User 116 can illustratively open and close a marketing calendar view that shows the details of various marketing campaigns (such as e-mails, landing pages, tasks, etc. that are included in the marketing campaigns) on a timeline view. User 116 can also view his or her accounts' or contacts' behavior relative to the marketing campaign (such as how they responded to different activities in the campaign). Further, user 116 can provide at least some configuration inputs to reconfigure the marketing campaign so that it is either directed to, or blocked from, certain contacts or accounts of user 116.

FIG. 1A-1 shows one example of recipient resolver 123 in more detail. FIG. 1B-1 shows an example of a flow diagram illustrating the operation of recipient resolver. FIGS. 1A-1 and 1B-1 will now be described in conjunction with one another.

Resolver 123 illustratively includes contact/segment mapper 141, segment computation engine 143, segment campaign mapper 145, contact/campaign mapper 147, contact/account mapper 149, campaign/account mapper 151 and it can include other items 153 as well. In operation, resolver 123 calculates which contacts 140 receive activities in which campaigns 130. It also calculates which accounts 142 contain contacts that will receive activities of which campaigns 130. Because these things can change over time, resolver 123 calculates these relationships intermittently or continuously. It outputs these relationships 155 and 157, respectively for use by sales system 104.

In doing so, resolver 123 first identifies a campaign for which segments are to be resolved. This is indicated by block 161 in FIG. 1B-1. This can be done in a variety of different ways. For instance, resolver 123 can calculate the relationships more frequently for campaigns that are currently being conducted or that are to be conducted in the near future than for those that are to be conducted further out in the future. This is because marketing users are more likely to change the marketing campaigns that are further in the future than those that are nearer. Therefore, resolver 123 does not spend as many computing resources on the more distant campaigns. This is indicated by block 163 in FIG. 1B-1. It can also determine which campaign to select based on configuration inputs or in other ways, as indicated by blocks 165 and 167.

When a campaign has been identified, it then identifies which segments have been identified for the campaign. This is indicated by block 169. They can be dynamic segments 171, static segments 173 or others 175. If there are any dynamic segments, then engine 143 runs the associated queries, and contact/segment mapper 141 identifies which contacts 140 belong to which segments for the campaign. This is indicated by block 177. Contact/campaign mapper 147 then identifies relationships 155 indicating which contacts 140 are mapped to this campaign. This is indicated by block 179. The relationships can indicate whether a contact is to receive any activities for the campaign (e.g., the contact is related to the campaign as a whole), or it can identify the specific activities within a campaign that the contact is to receive. These are indicated by blocks 181 and 183 in FIG. 1B-1. The relationships 155 can be identified in other ways as well, as indicated by block 185.

Contact/account mapper 149 then accesses pre-existing relationships that identify which contacts 140 are related to which accounts 142. It can identify the particular roles associated with the contacts 140, and other information as well. Accessing the contact/account relationships is indicated by block 187.

Campaign/account mapper 151 then generates the campaign/account relationships 157 that identify which accounts 142 have contacts 140 that will receive activities from the campaign. In one example, if a given account 142 has any contacts 140 that will receive any activities from the campaign, then a relationship is created. This is just one example. Generating the campaign/account relationships 155 is indicated by block 189 in FIG. 1B-1.

The relationships 155 and 157 are then output for use by sales system 104. This is indicated by block 191. Resolver 123 then determines whether it is time to process another campaign. This is indicated by block 193. If so, processing reverts to block 161. If not, resolver 123 waits until it is time to process another campaign.

FIG. 2-1 is a flow diagram illustrating one example of the operation of architecture 100, in more detail. FIGS. 3A-3P show various user interface displays. FIGS. 2-3P will now be described in conjunction with one another. It is first assumed that resolver 123 is resolving, or has resolved, relationships 155 and 157 as discussed above. Sales system 104 receives an input from sales user 116 indicating that user 116 is accessing sales system 104. This is indicated by block 180 in FIG. 2-1. This can be performed by user 116 providing authentication information 182, or other information 184.

In response, sales system 104 illustratively displays a sales system display. This is indicated by block 186 in FIG. 2-1. The sales system display can be generated in a variety of different contexts. For instance, it can be displayed in the context of the contacts 140 of user 116. This is indicated by block 188. It can also be generated in the context of the accounts 142 of user 116. This is indicated by block 190. Of course, it can be displayed in other contexts as well. This is indicated by block 192.

The sales system display illustratively includes a user input mechanism that allows user 116 to access collaboration system 152. In one example, system 104 then receives user actuation of the user input mechanism to access collaboration system 152. This is indicated by block 194 in FIG. 2-1. In response, collaboration system 152 illustratively provides a request to marketing system 102, requesting campaign data for this particular sales user 116, in this particular context. This is indicated by block 196 in FIG. 2-1. Marketing system 102 accesses the relationships generated by resolver 123 to determine which campaign information (for which campaigns 130) is to be returned to system 152. It obtains and returns that information.

Visualization component 154 then displays marketing campaign data relative to this context of the sales user 116. This is indicated by block 198. As examples, the visualization component 154 can display campaign details for marketing campaigns that have been run in the past. It can display campaign details for marketing campaigns that are currently run, and for those that are run in the future, or for any or all of these. This is indicated by block 200. The campaign details can include a wide variety of other information. For instance, they can indicate the various marketing activities that will be taken, and the timing of those activities, in the given marketing campaign. They can also include how recipients of the marketing campaign interacted with it, such as their online behavior in interacting with e-mails sent as part of the campaign, etc. The detailed information can include a wide variety of other details relative to the marketing campaigns that are displayed.

In one example, visualization component 154 displays the marketing campaigns on a calendar view, as indicated by block 202. For instance, the current marketing campaigns can be displayed on one calendar view, while giving the user the opportunity to scroll forward and backward in time (or select previous or subsequent periods in time) to view other marketing campaigns and their detailed information.

The visualization component 154 also illustratively displays how the marketing campaigns affect the particular context that user 116 is viewing. For instance, if user 116 is viewing the marketing campaign information in the context of the user's contacts, visualization component 154 will display which of those contacts will be touched by (such as which will receive) a marketing campaign or any activities of the campaign in the relevant time frame shown on the calendar view. If user 116 is viewing the campaign material in the context of the user's accounts, then visualization component 154 will display which accounts will be touched by the marketing campaigns. This is indicated by block 204 in FIG. 2-1.

Visualization component 154 can generate the display with configuration user input mechanisms that sense user interactions and allow user 116 to configure, or reconfigure, certain aspects of the marketing campaign. This is indicated by block 206. For instance, user 116 can be provided with user input mechanisms that allow the user to block certain accounts or contacts from receiving the marketing campaign (or from receiving certain portions of, or activities of, the marketing campaign). The user input mechanisms can also allow user 116 to unblock contacts or accounts as recipients of the marketing campaign or its activities.

Of course, the visualization can be generated in other ways as well. This is indicated by block 208.

Collaboration system 152 then determines whether it has sensed user actuation of an input mechanism on the visualization. This is indicated by block 210. If not, processing simply reverts to block 108 where the display is continued. If so, however, then collaboration system 152 takes the action corresponding to the actuated user input mechanism. This is indicated by block 212.

Some examples of actions that can be taken include reconfiguring the campaign to block or unblock recipients. This is indicated by block 214. A details user input mechanism can be actuated, corresponding to a given campaign, to display additional detailed information corresponding to that campaign. This is indicated by block 216. The user can illustratively actuate alert or notification user input mechanisms to subscribe to or otherwise configure alerts or notifications generated from the campaign. This is indicated by block 218. The user can illustratively actuate user input mechanisms to detect duplicate campaigns. For instance, it may be that, for some reason, a given contact or a given account has been scheduled to receive two instances of the same marketing campaign. User 116 can illustratively actuate a user input mechanism to detect and remedy this as well. This is indicated by block 220. Collaboration system 152 can take other actions as well, and this is indicated by block 222.

FIGS. 3A-3N show examples of user interface displays that can be generated by collaboration system 152. FIG. 3A, for instance, shows an example of a user interface display 224 that is a sales system display that can be generated when user 116 accesses sales system 104. It is illustratively displayed in the context of the user's contacts 140. Therefore, it includes a set of active contacts 226. It can be seen that the system has sensed user actuation of a drop down menu 228 and selected a marketing portal user input mechanism 230. Actuation of mechanism 230 indicates that the user wishes to access collaboration system 152 in the context of the user's contacts.

In response, visualization component 154 obtains campaign information for campaigns 130 that will be received by the contacts 140 of user 116, from marketing system 102, and displays it. FIG. 3B shows one example of this. It can be seen in FIG. 3B that visualization component 154 has generated a user interface display 232 that shows a set of marketing campaigns 234, 236 and 238 displayed on a calendar view 239. Also, the contacts of user 116 that are touched by those marketing campaigns are shown in a contact list displayed in pane 240. Pane 240 lists the various marketing campaigns relative to each contact. Each has a user input mechanism 242, 244, 246 and 248 associated therewith, under each contact. Interaction with (e.g., actuation of), mechanisms 242-248 can be sensed to reconfigure whether the identified marketing campaign will be received by the given contact. For instance, element 242 indicates that contact “John Smith” has been blocked from receiving the “Winter Holiday Campaign” represented by display element 234. However, element 244 indicates that “John Smith” will receive the “Summer Campaign” represented by display element 236.

FIG. 3C shows display 232 which is similar to that shown in FIG. 3B, except that the user has actuated a portion of display element 246 in pane 240. Thus, the details of the “Winter Holiday Campaign” are displayed in pane 240. FIG. 3C also shows that the user has actuated display element 238 so that the details of the “Spring Blitz Campaign” are displayed on the calendar view. The details can include a set of activities that will be conducted in the campaign. The activities can be across multiple channels, such as email, SMS, social network, events, web landing pages, etc. If a display element for any activity is actuated, the details of that activity can be displayed as well.

FIG. 3D shows one example of user interface display 232 where the user is actuating another portion of display element 246 to change the configuration of the corresponding marketing campaign. By actuating display element 246, user 116 is controlling the system to reconfigure the marketing campaign so that the contact “Sue Wilson” will now be unblocked, and receive it. It can be seen in FIGS. 3E and 3F that display element 246 has now changed to indicate that “Sue Wilson” will receive the “Winter Holiday Campaign”.

FIG. 3G shows an example of another user interface display 260. User interface display 260 is an example of a sales display that is generated by system 104 when user 116 accesses system 104 in the “accounts” context. Therefore, it can be seen that active accounts information has been accessed and display 260 includes a set of active accounts 262 for user 116. Again, user 116 has invoked drop down menu 228 and is actuating user input mechanism 230 to establish a portal to marketing system 102.

In response, as shown on display 263 in FIG. 3H, visualization component 154 displays the marketing campaigns illustrated above with respect to FIG. 3B on the calendar display 239. However, instead of being in the context of the user's contacts, it is now in the context of the user's accounts. Therefore, the accounts that will be touched by any of the marketing campaigns shown on calendar display 235 are displayed on account pane 264 on display 263. In one example, each account in pane 264 has a corresponding indicator 265, 266 showing a number of contacts in that account that will receive (or are blocked from receiving) a marketing campaign. Element 265, for instance, shows that 15 contacts in the ACME account are blocked from receiving a selected marketing campaign, while element 266 shows that 10 contacts in the Contoso account will receive the campaign.

FIG. 3I shows that user 116 can further configure a marketing campaign with respect to individual contacts at a given account. For instance, FIG. 3H shows that the user is actuating the portion of the display element 266 corresponding to the “Contoso” account that shows the contacts at Contoso who will receive the campaign. In response, visualization component 154 retrieves contact information for that account from contacts 140 or accounts 142 (shown in FIG. 1) and displays that information, such as in a pop-up display 270 shown in FIG. 3I. The contacts are also shown in two sets. A first set 272 indicates contacts at the specified account that are to receive the marketing campaign. The second set 274 identifies contacts at the given account that are blocked from receiving the campaign. Interaction with a set of actuators 276 by user 116 can be sensed and used to add or remove recipients from the two sets 272 and 274. For instance, by selecting a recipient from set 272 and actuating one of the actuators 276, that recipient can be moved to the blocked list 274, and vice versa.

Whenever the system senses user 116 actuation of any configuration user input mechanism for reconfiguring the marketing campaign, campaign configuration component 156 provides this configuration information to marketing system 102, where the marketing campaign is reconfigured.

FIGS. 3J and 3K show that even more detailed information can be provided as well. For instance, in one example, user 116 can drill into detailed behavioral information about how a given contact has behaved relative to a current or past marketing campaign. As one example, if the system senses that the user 116 is hovering a cursor over (or otherwise selecting) a contact on a display, then the visualization component illustratively obtains the detail information for that contact and displays it for the user. FIG. 3J, for instance, shows a display 267 which includes detailed information indicative of how a corresponding contact has reacted to marketing activities (in this example, emails, websites and landing pages, although these are examples only). If user 116 wishes to see even more detailed information, the user 116 can actuate a portion of display 267 and an even more detailed display, such as display 269 shown in FIG. 3K, is displayed. In the example of FIG. 3K, display 269 breaks down each key performance indicator shown in FIG. 3J, even further. This type of detail drilling can be continued to a desired depth.

FIG. 3L-1 is an example of a user interface display 278 that can be displayed by sales system 104, when user 116 accesses sales system 104. It illustratively includes a marketing alerts user input mechanism 280 that can be actuated by the user to configure marketing alerts that are generated by the marketing campaigns in marketing system 102. By way of example, marketing system 102 can be configured to generate an alert or notification whenever any action or interaction takes place.

FIG. 3L-2 shows another user interface display 282 that can be displayed. It includes a drop down box 284 that has a user input mechanism 286 that allows user 116 to configure the alert settings for alerts generated by marketing system 102. If the user actuates either of these user input mechanisms (280 or 286), alert configuration component 158 illustratively navigates user 116 through a set of user interface displays that allow the user to set alerts or notifications.

For instance, FIG. 3M shows one example of a user interface display 288 that illustrates this. The user interface display 288 illustratively displays a current set of the user's alerts, and includes an alert name 290, an event that generates the alert 294, a frequency with which that event occurs at 296, and an active/inactive status 298 for the alert. User 116 can elect to receive alerts by actuating a selection user input mechanism 300 corresponding to each alert. In that case, the actuation is sensed and alert configuration component 158 provides this configuration information to marketing system 102, so that campaign execution engine 124 will send a notification or alert to collaboration system 152 when the corresponding alert or notification is generated by the corresponding marketing campaign.

FIG. 3N shows another example of a user interface display 302 that allows user 116 to configure an alert that the user wishes to receive. Therefore, instead of simply selecting them from a list as shown in FIG. 3M, the user can configure the alert himself or herself. Thus, a name user input mechanism 304 allows the user to insert a name. The user can select a type of action that will generate the alert, by interacting with user input mechanism 306. When the user selects an action using mechanism 306, then an action-specific configuration mechanism 307 is displayed so the user can further define the action. In the example of FIG. 3N, the user has selected to receive an alert when a contact visits a website. Thus, mechanism 307 is displayed so the user can identify various websites that are to be monitored for the actions selected, and various contacts the user wishes to be monitored. The website identification mechanism is shown generally at 308, and the contact identification mechanism is shown generally at 310. The user can identify fields that are to be included in the alert or notifications by interacting with user input mechanism 312, and the user can specify a delivery method for the alert by interacting with user input mechanism 314. In addition, the user can illustratively specify a frequency with which the alerts are to be monitored and generated, by interacting with user input mechanism 316. Some alerts may be more interesting or urgent, and the frequency can be set to generate the alert immediately. Others may be less interesting so the frequency can be set to send a summary notification of all instances of that particular type of alert that were sent in the last week, as an example.

FIG. 3O shows another example of a user interface display 320. User interface display 320 can again be a sales system display generated by sales system 104, when user 116 accesses system 104. It can be seen that sales system 104 is generated in the context of the user's contacts. Also, the user has actuated a drop down menu 322 that includes a “Detect Duplicates” user input mechanism 324. When the user actuates mechanism 324, collaboration system 152 senses the interaction and illustratively detects any of the contacts 140 of user 116 which will be receiving two instances (e.g., duplicates) of the same marketing campaign. If any are detected, they can be displayed to user 116 so that remedial action can be taken.

FIG. 3P shows one example of a user interface display 326 that indicates this. It can be seen that the user's contact “John Smith” is scheduled to receive two instances of the marketing campaign entitled “Summer Campaign (200)”. Thus, user 116 can easily block “John Smith” from receiving one of those instances of the marketing campaign.

It can thus be seen that a communication system generated in one computing system can be organized and graphically displayed for a user of a second computing system. The context of the user of the second computing system can be sensed so the communication system is displayed in the sensed context. For instance, marketing campaigns can be organized and graphically displayed for a sales user, based on that user's accounts or contacts. The sales user interaction can be sensed and used to open or close the marketing calendar to view the details of a campaign (such as the activities that will be conducted during the campaign, how customers are behaving or reacting in response to the campaign, etc.). It also allows the sales user to configure operation of the campaign to block a contact from receiving one or more campaigns within the system or to unblock one or more recipients to the campaign. Further, it allows user 116 to easily and automatically subscribe to alerts or notifications, as well as to detect duplicates. This increases productivity and efficiency of both the computing systems and the users. Because different users can collaborate in configuring the communication system (e.g., the marketing campaign), the communication system can be configured for the most efficient operations. For instance, communications are not sent to recipients where they may be unwanted. Duplicate campaigns can be easily detected and eliminated. A user that may have more knowledge about a potential recipient can reconfigure the campaign himself or herself, without having to communicate with the author of the campaign and then hoping they fix the campaign.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

FIG. 4 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 4, some items are similar to those shown in FIG. 1 and they are similarly numbered. FIG. 4 specifically shows that marketing system 102 and sales system 104 can be located in cloud 502 (which can be public, private, or a combination where portions are public while others are private). Therefore, users 110 and 116 use user devices 504 and 505 to access those systems through cloud 502.

FIG. 4 also depicts another example of a cloud architecture. FIG. 4 shows that it is also contemplated that some elements of architecture 100 can be disposed in cloud 502 while others are not. By way of example, data stores 128, 138 can be disposed outside of cloud 502, and accessed through cloud 502. In another example, collaboration system 152 can also be outside of cloud 502. Other systems 102 and 104 can reside elsewhere as well. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

FIG. 5 is a simplified block diagram of one illustrative embodiment of a handheld or mobile computing device that can be used as a user's or client's hand held device 16, in which the present system (or parts of it) can be deployed. FIGS. 6-7 are examples of handheld or mobile devices.

FIG. 5 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processors 126 or 162 from FIG. 1 or processors in user devices 504 and 505 in FIG. 4) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client business system 24 which can run various business applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 6 shows one embodiment in which device 16 is a tablet computer 600. In FIG. 6, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can be used as well. Device 16 can be a feature phone, smart phone or mobile phone. The phone includes a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1Xrtt, and Short Message Service (SMS) signals. In some embodiments, the phone also includes a Secure Digital (SD) card slot that accepts a SD card.

The mobile device can be a personal digital assistant (PDA) or a multimedia player or a tablet computing device, etc. (hereinafter referred to as PDA). The PDA can include an inductive screen that senses the position of a stylus (or other pointers, such as a user's finger) when the stylus is positioned over the screen. This allows the user to select, highlight, and move items on the screen as well as draw and write. The PDA also includes a number of user input keys or buttons which allow the user to scroll through menu options or other display options which are displayed on the display, and allow the user to change applications or select user input functions, without contacting the display. The PDA can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 7 shows that the phone can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

FIG. 8 is one example of a computing environment in which architecture 100, or parts of it, (for example) can be deployed. With reference to FIG. 8, an example system for implementing some embodiments includes a general-purpose computing device in the form of a computer 810. Components of computer 810 may include, but are not limited to, a processing unit 820 (which can comprise processor 126 or 162 or processors in user devices 504 or 505), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 8.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable volatile/nonvolatile computer storage media. By way of example only, FIG. 8 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system architecture that comprises a first computing system that controls a communication system, the first computing system comprising:

a communication system creation component that generates a creation user interface display with creation user input mechanisms and that senses user interaction with the creation user input mechanisms to define communication system data that defines the communication system, the communication system including a set of communication activities;

a segment computation engine that accesses the communication system data for the communication system and identifies a set of segments to which the communication activities in the communication system are directed;

a recipient resolver that receives contact information from a second computing system, and the identified set of segments, and maps contacts identified in the contact information to the communication system, in a corresponding contact/communication system map, based on the identified set of segments; and

a communication system execution engine that accesses the communication system data and the corresponding contact/communication system map, and automatically controls the communication system to perform the set of communication activities, using a plurality of different communication channels, relative to the contacts.

Example 2 is the computing system architecture of any or all previous examples wherein the recipient resolver receives account information indicative of accounts in the second computing system and maps accounts identified in the account information to the communication system, in a corresponding account/communication system map, based on the identified set of segments.

Example 3 is the computing system architecture of any or all previous examples wherein the first computing system further comprises:

a campaign monitoring system that senses recipient interaction with the communication activities and generates a set of performance measures indicative of a performance of the communication activities, based on the sensed recipient interaction.

Example 4 is the computing system architecture of any or all previous examples wherein the recipient resolver comprises:

a segment/communication system mapper that maps the identified set of segments to the communication system in a segment/communication system map;

a contact/segment mapper that identifies contacts in the contact information, correlates them to the identified set of segments and maps them to the identified set of segments in a contact/segment map; and

a contact/communication system mapper that generates the contact/communication system map based on the segment/communication system map and the contact/segment map.

Example 5 is the computing system architecture of any or all previous examples wherein the recipient resolver further comprises:

a contact/account mapper that maps the contacts to the accounts in the account information, in a contact/account map; and

a communication system/account mapper that generates the account/communication system map based on the contact/account map and the contact/communication system map.

Example 6 is the computing system architecture of any or all previous examples wherein the recipient resolver identifies individual activities in the set of communication activities and generates the contact/communication system map to identify which of the contacts are to receive which of the individual activities.

Example 7 is the computing system architecture of any or all previous examples wherein the recipient resolver identifies individual activities in the set of communication activities and generates the account/communication system map to identify which of the accounts are to receive which of the individual activities.

Example 8 is the computing system architecture of any or all previous examples, and further comprising the second computing system, the second computing system comprising:

second computing system functionality that controls the second computing system to perform operations different from operations performed in the first computing system; and

a visualization component that detects a user context in the second computing system and displays at least a portion of the communication system data at the second computing system, in the detected context.

Example 9 is the computing system architecture of any or all previous examples wherein the visualization system detects, as the context, that a user of the second computing system has opened an application in the second computing system in an accounts context, in which the user views account information corresponding to a set of user accounts, and displays a visual indication of how the communication activities will affect the user accounts.

Example 10 is the computing system architecture of any or all previous examples wherein the visualization system detects, as the context, that a user of the second computing system has opened an application in the second computing system in a contacts context, in which the user views account information corresponding to a set of user contacts, and displays a visual indication of how the communication activities will affect the user contacts.

Example 11 is the computing system architecture of any or all previous examples wherein the second computing system further comprises:

a communication system configuration component that senses user configuration interactions and reconfigures the communication system, in the first computing system, based on the user interactions.

Example 12 is the computing system architecture of any or all previous examples wherein the communication system configuration component senses user blocking interactions and reconfigures the communication system, in the first computing system, to block communication activities from being performed relative to given user accounts or given user contacts, based on the user blocking interactions.

Example 13 is the computing system architecture of any or all previous examples wherein the second co putting system further comprises:

an alert configuration component that senses user alert inputs and reconfigures the communication system, in the first computing system, to alert the user when a contact or account interacts with a communication activity, based on the user alert inputs.

Example 14 is the computing system architecture of any or all previous examples wherein the visualization component generates a visualization, at the second computing system, of results of the communication system execution engine executing the communication system, during runtime of the campaign execution engine.

Example 15 is the computing system architecture of any or all previous examples wherein the first computing system comprises a marketing computing system, the communication system comprises a multi-channel marketing campaign and wherein the second computing system comprises a sales computing system, both the marketing computing system and the sales computing system being deployed in an enterprise computing system of an organization.

Example 16 is a computing system, comprising:

a set of computing system functionality that controls the computing system to perform a set of functions;

a collaboration system that obtains communication system data from a different computing system, the communication system data defining communication activities to be performed relative to a set of recipients, over multiple communication channels, the collaboration system sensing user collaboration inputs and reconfiguring the communication activities based on the sensed user collaboration inputs; and

a visualization component that detects a user context in the computing system and displays at least a portion of the communication system data at the computing system, in the detected context.

Example 17 is the computing system of any or all previous examples wherein the visualization component detects, as the context, that a user of the computing system has opened an application in an accounts context, in which the user views account information corresponding to a set of user accounts, and displays a visual indication of how the communication activities will affect the user accounts.

Example 18 is the computing system of any or all previous examples wherein the visualization component detects, as the context, that a user of the computing system has opened an application in the computing system in a contacts context, in which the user views account information corresponding to a set of user contacts, and displays a visual indication of how the communication activities will affect the user contacts.

Example 19 is the computing system of claim 16 and further comprising:

a communication system configuration component that senses user blocking interactions and reconfigures the communication system, in the different computing system, to block communication activities from being performed relative to given user accounts or given user contacts, based on the user blocking interactions; and

a notification configuration component that senses user alert inputs and reconfigures the communication system, in the different computing system, to notify the user when a contact or account interacts with a communication activity, based on the user alert inputs.

Example 20 is a computer implemented method, comprising:

accessing, at a first computing system, communication program data indicative of a set of multi-channel communication activities that are to be performed by a second computing system, and a set of recipients of the multi-channel communication activities;

detecting a current context of a user in the first computing system;

displaying the communication program data at the first computing system in the detected context;

sensing user collaboration inputs at the first computing system;

reconfiguring recipients of the multi-channel communication activities based on the sensed collaboration inputs; and visually displaying, at the first computing system, execution results indicative of recipient responsive interactions with the multi-channel communication activities, as the multi-channel communication activities are being performed at the second computing system.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system architecture that comprises a first computing system that controls a communication system, the first computing system comprising:
a communication system creation component that generates a creation user interface display with creation user input mechanisms and that senses user interaction with the creation user input mechanisms to define communication system data that defines the communication system, the communication system including a set of communication activities;
a segment computation engine that accesses the communication system data for the communication system and identifies a set of segments to which the communication activities in the communication system are directed;
a recipient resolver that receives contact information from a second computing system, and the identified set of segments, and maps contacts identified in the contact information to the communication system, in a corresponding contact/communication system map, based on the identified set of segments; and
a communication system execution engine that accesses the communication system data and the corresponding contact/communication system map, and automatically controls the communication system to perform the set of communication activities, using a plurality of different communication channels, relative to the contacts.

2. The computing system architecture of claim 1 wherein the recipient resolver receives account information indicative of accounts in the second computing system and maps accounts identified in the account information to the communication system, in a corresponding account/communication system map, based on the identified set of segments.

3. The computing system architecture of claim 2 wherein the first computing system further comprises:
a campaign monitoring system that senses recipient interaction with the communication activities and generates a set of performance measures indicative of a performance of the communication activities, based on the sensed recipient interaction.

4. The computing system architecture of claim 2 wherein the recipient resolver comprises:
a segment/communication system mapper that maps the identified set of segments to the communication system in a segment/communication system map;
a contact/segment mapper that identifies contacts in the contact information, correlates them to the identified set of segments and maps them to the identified set of segments in a contact/segment map; and
a contact/communication system mapper that generates the contact/communication system map based on the segment/communication system map and the contact/segment map.

5. The computing system architecture of claim 4 wherein the recipient resolver further comprises:
a contact/account mapper that maps the contacts to the accounts in the account information, in a contact/account map; and
a communication system/account mapper that generates the account/communication system map based on the contact/account map and the contact/communication system map.

6. The computing system architecture of claim 2 wherein the recipient resolver identifies individual activities in the set of communication activities and generates the contact/communication system map to identify which of the contacts are to receive which of the individual activities.

7. The computing system architecture of claim 2 wherein the recipient resolver identifies individual activities in the set of communication activities and generates the account/communication system map to identify which of the accounts are to receive which of the individual activities.

8. The computing system architecture of claim 1, and further comprising the second computing system, the second computing system comprising:
second computing system functionality that controls the second computing system to perform operations different from operations performed in the first computing system; and
a visualization component that detects a user context in the second computing system and displays at least a portion of the communication system data at the second computing system, in the detected context.

9. The computing system architecture of claim 8 wherein the visualization system detects, as the context, that a user of the second computing system has opened an application in the second computing system in an accounts context, in which the user views account information corresponding to a set of user accounts, and displays a visual indication of how the communication activities will affect the user accounts.

10. The computing system architecture of claim 8 wherein the visualization system detects, as the context, that a user of the second computing system has opened an application in the second computing system in a contacts context, in which the user views account information corresponding to a set of user contacts, and displays a visual indication of how the communication activities will affect the user contacts.

11. The computing system architecture of claim 8 wherein the second computing system further comprises:
a communication system configuration component that senses user configuration interactions and reconfigures the communication system, in the first computing system, based on the user interactions.

12. The computing system architecture of claim 11 wherein the communication system configuration component senses user blocking interactions and reconfigures the communication system, in the first computing system, to block communication activities from being performed relative to given user accounts or given user contacts, based on the user blocking interactions.

13. The computing system architecture of claim 8 wherein the second co putting system further comprises:
an alert configuration component that senses user alert inputs and reconfigures the communication system, in the first computing system, to alert the user when a contact or account interacts with a communication activity, based on the user alert inputs.

14. The computing system architecture of claim 8 wherein the visualization component generates a visualization, at the second computing system, of results of the communication system execution engine executing the communication system, during runtime of the campaign execution engine.

15. The computing system architecture of claim 8 wherein the first computing system comprises a marketing computing system, the communication system comprises a multi-channel marketing campaign and wherein the second computing system comprises a sales computing system, both the marketing computing system and the sales computing system being deployed in an enterprise computing system of an organization.

16. A computing system, comprising:
a set of computing system functionality that controls the computing system to perform a set of functions;
a collaboration system that obtains communication system data from a different computing system, the communication system data defining communication activities to be performed relative to a set of recipients, over multiple communication channels, the collaboration system sensing user collaboration inputs and reconfiguring the communication activities based on the sensed user collaboration inputs; and
a visualization component that detects a user context in the computing system and displays at least a portion of the communication system data at the computing system, in the detected context.

17. The computing system of claim 16 wherein the visualization component detects, as the context, that a user of the computing system has opened an application in an accounts context, in which the user views account information corresponding to a set of user accounts, and displays a visual indication of how the communication activities will affect the user accounts.

18. The computing system of claim 16 wherein the visualization component detects, as the context, that a user of the computing system has opened an application in the computing system in a contacts context, in which the user views account information corresponding to a set of user contacts, and displays a visual indication of how the communication activities will affect the user contacts.

19. The computing system of claim 16 and further comprising:
a communication system configuration component that senses user blocking interactions and reconfigures the communication system, in the different computing system, to block communication activities from being performed relative to given user accounts or given user contacts, based on the user blocking interactions; and
a notification configuration component that senses user alert inputs and reconfigures the communication system, in the different computing system, to notify the user when a contact or account interacts with a communication activity, based on the user alert inputs.

20. A computer implemented method, comprising:
accessing, at a first computing system, communication program data indicative of a set of multi-channel communication activities that are to be performed by a second computing system, and a set of recipients of the multi-channel communication activities;
detecting a current context of a user in the first computing system;
displaying the communication program data at the first computing system in the detected context;
sensing user collaboration inputs at the first computing system;
reconfiguring recipients of the multi-channel communication activities based on the sensed collaboration inputs; and
visually displaying, at the first computing system, execution results indicative of recipient responsive interactions with the multi-channel communication activities, as the multi-channel communication activities are being performed at the second computing system.
